(19) United States
(12) Patent Application Publication
(10) Pub. No.: US 2025/0142219 A1
(43) Pub. Date: May 1, 2025

(54) IMAGING SUPPORT DEVICE, IMAGING APPARATUS, IMAGING SUPPORT METHOD, AND PROGRAM

(71) Applicant: FUJIFILM Corporation, Tokyo (JP)

(72) Inventor: Tetsu WADA, Kanagawa (JP)

(73) Assignee: FUJIFILM Corporation, Tokyo (JP)

(21) Appl. No.: 19/001,354

(22) Filed: Dec. 24, 2024

Related U.S. Application Data
(63) Continuation of application No. PCT/JP2023/023218, filed on Jun. 22, 2023.

(30) Foreign Application Priority Data
Aug. 17, 2022 (JP) 2022-130092

(51) Int. Cl. H04N 23/71; H04N 23/72; H04N 23/73; H04N 23/74

(52) U.S. Cl. CPC H04N 23/71; H04N 23/72; H04N 23/73; H04N 23/74

(57) ABSTRACT

An imaging support device includes a processor configured to control an exposure time of a photoelectric conversion region of an image sensor having the photoelectric conversion region in which plural pixels are two-dimensionally disposed. The processor is configured to, in a case where an incidence ray on the photoelectric conversion region causes a difference in brightness along one direction in the photoelectric conversion region, perform a control of reducing the exposure time from a divided region on a darker side to a divided region on a brighter side of a plurality of divided regions into which the photoelectric conversion region is divided along the one direction.

### CROSS-REFERENCE TO RELATED APPLICATIONS

This application is a continuation application of International Application No. PCT/JP2023/023218, filed Jun. 22, 2023, the disclosure of which is incorporated herein by reference in its entirety. Further, this application claims priority from Japanese Patent Application No. 2022-130092, filed Aug. 17, 2022, the disclosure of which is incorporated herein by reference in its entirety.

### BACKGROUND

### 1. Technical Field

The disclosed technology relates to an imaging support device, an imaging apparatus, an imaging support method, and a program.

### 2. Related Art

JP2014-176065A discloses an imaging apparatus. The imaging apparatus according to JP2014-176065A is provided with a pixel circuit that outputs a pixel signal having a signal level corresponding to an exposure amount by reading out the pixel signal in a non-destructive manner, and a photoelectric conversion unit in which a plurality of pixel circuits are arranged in a two-dimensional matrix. The imaging apparatus according to JP2014-176065A is provided with a row decoder that resets the plurality of pixel circuits in units of rows and that selects a plurality of pixel circuits for outputting the pixel signal in units of rows, a plurality of A/D converters that generate pixel data by performing A/D conversion on the pixel signal, and an image data generation unit.

The image data generation unit generates first image data by obtaining a difference between pixel data generated at a first time point after reset and pixel data generated at a time point after an elapse of a first exposure time from the first time point in each of the plurality of pixel circuits. The image data generation unit generates second image data by obtaining a difference between pixel data generated at a second time point after the first time point and pixel data generated at a time point after an elapse of a second exposure time longer than the first exposure time from the second time point.

JP2022-007039A discloses an imaging apparatus. The imaging apparatus according to JP2022-007039A comprises a light source and an imaging element that images a subject using reflected light that is light emitted from the light source and reflected from the subject. The imaging apparatus according to JP2022-007039A comprises a control unit that reduces a part of an optical path of the reflected light heading to the imaging element from the subject, the part passing through a region in which emitted light that is light emitted from the light source travels, by controlling an emission direction in which the light source emits light. The control unit acquires an image of the subject captured by the imaging element, by controlling a light emission timing of the light source and an exposure timing of the imaging element.

JP2021-027409A discloses a control device comprising a circuit configured to set an upper limit value of an exposure time and determine an exposure time of an imaging apparatus within a range less than or equal to an upper limit time based on an exposure control value of the imaging apparatus.

### SUMMARY

One embodiment according to the disclosed technology provides an imaging support device, an imaging apparatus, an imaging support method, and a program capable of causing an image sensor to generate an image having little brightness unevenness, even in a case where an incident ray on the photoelectric conversion region causes a difference in brightness along one direction in a photoelectric conversion region.

According to a first aspect of the disclosed technology, there is provided an imaging support device comprising a processor configured to control an exposure time of a photoelectric conversion region of an image sensor having the photoelectric conversion region in which a plurality of pixels are two-dimensionally disposed, in which the processor is configured to, in a case where an incidence ray on the photoelectric conversion region causes a difference in brightness along one direction in the photoelectric conversion region, perform a control of reducing the exposure time from a divided region on a darker side to a divided region on a brighter side of a plurality of divided regions into which the photoelectric conversion region is divided along the one direction.

According to a second aspect of the disclosed technology, in the imaging support device according to the first aspect, the divided region is a region in which the pixels are linearly arranged in a direction intersecting with the one direction.

According to a third aspect of the disclosed technology, in the imaging support device according to the first or second aspect, the incidence ray is light including reflected light obtained by reflection, on a subject, of supplementary light emitted from an illumination device used for imaging using the image sensor.

According to a fourth aspect of the disclosed technology, in the imaging support device according to any one of the first to third aspects, the processor is configured to, in a case where a mechanical shutter and/or an electronic shutter is used for imaging using the image sensor, control the exposure time of the photoelectric conversion region by controlling the mechanical shutter and/or the electronic shutter.

According to a fifth aspect of the disclosed technology, in the imaging support device according to any one of the first to fourth aspects, the processor is configured to reduce the exposure time from the divided region on the darker side to the divided region on the brighter side of the plurality of divided regions by controlling an exposure start timing and/or an exposure end timing for the plurality of divided regions.

According to a sixth aspect of the disclosed technology, in the imaging support device according to the fifth aspect, the processor is configured to perform a control of delaying the exposure start timing for the plurality of divided regions from the divided region on the darker side to the divided region on the brighter side of the plurality of divided regions and matching the exposure end timing for the plurality of divided regions.

According to a seventh aspect of the disclosed technology, in the imaging support device according to the sixth aspect, the processor is configured to perform a control of matching the exposure end timing for the plurality of divided regions using a global shutter system.

According to an eighth aspect of the disclosed technology, in the imaging support device according to the fifth aspect, the processor is configured to perform a control of matching the exposure start timing for the plurality of divided regions and delaying the exposure end timing for the plurality of divided regions from the divided region on the brighter side to the divided region on the darker side of the plurality of divided regions.

According to a ninth aspect of the disclosed technology, in the imaging support device according to the eighth aspect, the processor is configured to perform a control of matching the exposure start timing for the plurality of divided regions using a global shutter system.

According to a tenth aspect of the disclosed technology, in the imaging support device according to the fifth aspect, the processor is configured to perform a control of delaying the exposure start timing for the plurality of divided regions from the divided region on the darker side to the divided region on the brighter side of the plurality of divided regions, delaying the exposure end timing for the plurality of divided regions from the divided region on the darker side to the divided region on the brighter side of the plurality of divided regions, and reducing the exposure time from the divided region on the darker side to the divided region on the brighter side of the plurality of divided regions.

According to an eleventh aspect of the disclosed technology, in the imaging support device according to any one of the first to tenth aspects, the exposure time for each divided region from the divided region on the darker side to the divided region on the brighter side of the plurality of divided regions is determined in accordance with a first degree of difference, and the first degree of difference is a degree of difference between a signal level of a first reference region in the photoelectric conversion region in a case where the exposure time of the photoelectric conversion region is shorter than a first reference exposure time, and a plurality of signal levels obtained from the plurality of divided regions.

According to a twelfth aspect of the disclosed technology, in the imaging support device according to the eleventh aspect, the first reference exposure time is shorter than a time in which the signal level of the first reference region is saturated.

According to a thirteenth aspect of the disclosed technology, in the imaging support device according to any one of the first to tenth aspects, the exposure time for each divided region from the divided region on the darker side to the divided region on the brighter side of the plurality of divided regions is determined in accordance with a second degree of difference, the second degree of difference is a degree of difference between a signal level of a second reference region in the photoelectric conversion region in a case where the exposure time of the photoelectric conversion region is a first exposure time, and a plurality of signal levels obtained from the plurality of divided regions, and the exposure time for each divided region from the divided region on the darker side to the divided region on the brighter side of the plurality of divided regions is adjusted to a time in which the plurality of signal levels fall within a reference range.

According to a fourteenth aspect of the disclosed technology, in the imaging support device according to any one of the first to tenth aspects, in a case where an imaging range is changed in imaging using the image sensor, the exposure time for each divided region from the divided region on the darker side to the divided region on the brighter side of the plurality of divided regions before the imaging range is changed is determined in accordance with a third degree of difference, the third degree of difference is a degree of difference between a signal level of a third reference region in the photoelectric conversion region in a case where the exposure time of the photoelectric conversion region is a second exposure time, and a plurality of signal levels obtained from the plurality of divided regions, and the exposure time for each divided region from the divided region on the darker side to the divided region on the brighter side of the plurality of divided regions after the imaging range is changed is determined in accordance with a second reference exposure time determined for the third reference region and with the third degree of difference.

According to a fifteenth aspect of the disclosed technology, in the imaging support device according to any one of the first to tenth aspects, in a case where a flash is used in accordance with a timing at which imaging using the image sensor is performed, the exposure time for each divided region from the divided region on the darker side to the divided region on the brighter side of the plurality of divided regions is determined in accordance with a fourth degree of difference, and the fourth degree of difference is a degree of difference between a signal level of a fourth reference region in the photoelectric conversion region in a case where the exposure time of the photoelectric conversion region is a third exposure time determined in accordance with the flash, and a plurality of signal levels obtained from the plurality of divided regions.

According to a sixteenth aspect of the disclosed technology, in the imaging support device according to the fifteenth aspect, in a case where a stop is adjusted in imaging using the image sensor, the third exposure time is determined in accordance with the flash and with a value of the stop.

According to a seventeenth aspect of the disclosed technology, in the imaging support device according to any one of the first to sixteenth aspects, in a case where the exposure time of the photoelectric conversion region is determined in accordance with a moving speed of a focal-plane shutter, the moving speed is determined based on a result of regression analysis performed based on a signal level of a fifth reference region in the photoelectric conversion region in a case where the photoelectric conversion region is exposed for a fourth exposure time and on a plurality of signal levels obtained from the plurality of divided regions.

According to an eighteenth aspect of the disclosed technology, there is provided an imaging apparatus comprising the imaging support device according to any one of the first to seventeenth aspects, and the image sensor.

According to a nineteenth aspect of the disclosed technology, there is provided an imaging support method comprising exposing a photoelectric conversion region of an image sensor having the photoelectric conversion region in which a plurality of pixels are two-dimensionally disposed, and performing, in a case where an incidence ray on the photoelectric conversion region causes a difference in brightness along one direction in the photoelectric conversion region, a control of reducing an exposure time from a divided region on a darker side to a divided region on a brighter side of a plurality of divided regions into which the photoelectric conversion region is divided along the one direction.

According to a twentieth aspect of the disclosed technology, there is provided a program causing a computer that controls an exposure time of a photoelectric conversion region of an image sensor having the photoelectric conversion region in which a plurality of pixels are two-dimensionally disposed, to execute a process comprising performing, in a case where an incidence ray on the photoelectric conversion region causes a difference in brightness along one direction in the photoelectric conversion region, a control of reducing the exposure time from a divided region on a darker side to a divided region on a brighter side of a plurality of divided regions into which the photoelectric conversion region is divided along the one direction.

### BRIEF DESCRIPTION OF THE DRAWINGS

Exemplary embodiments according to the technique of the present disclosure will be described in detail based on the following figures, wherein:

FIG. 1 is a front view illustrating an example of an imaging system according to first to sixth embodiments;

FIG. 2 is a conceptual diagram illustrating an example of an aspect of imaging a subject via an imaging apparatus included in the imaging system according to the first to sixth embodiments;

FIG. 3 is a block diagram illustrating an example of a hardware configuration of the imaging apparatus included in the imaging system according to the first embodiment;

FIG. 4 is a conceptual diagram illustrating an example of an aspect of controlling an exposure time of each pixel column in a photoelectric conversion region of an image sensor included in the imaging apparatus according to the first embodiment;

FIG. 5 is a flowchart illustrating an example of a flow of exposure time control processing according to the first embodiment;

FIG. 6 is a conceptual diagram illustrating a first modification example of the aspect of controlling the exposure time of each pixel column in the photoelectric conversion region of the image sensor included in the imaging apparatus according to the first embodiment;

FIG. 7 is a conceptual diagram illustrating a second modification example of the aspect of controlling the exposure time of each pixel column in the photoelectric conversion region of the image sensor included in the imaging apparatus according to the first embodiment;

FIG. 8 is a block diagram illustrating an example of a configuration of a controller included in the imaging apparatus according to the second to fifth embodiments;

FIG. 9 is a flowchart illustrating an example of a flow of exposure time determination processing according to the second embodiment;

FIG. 10 is a flowchart illustrating an example of a flow of the exposure time determination processing according to the third embodiment;

FIG. 11A is a flowchart illustrating an example of a flow of the exposure time determination processing according to the fourth embodiment;

FIG. 11B is a continuation of the flowchart illustrated in FIG. 11A;

FIG. 12 is a flowchart illustrating an example of a flow of the exposure time determination processing according to the fifth embodiment;

FIG. 13 is a flowchart illustrating a modification example of the flow of the exposure time determination processing according to the fifth embodiment;

FIG. 14 is a block diagram illustrating an example of a configuration of a controller included in the imaging apparatus according to the sixth embodiment;

FIG. 15 is a flowchart illustrating an example of a flow of shutter speed determination processing according to the sixth embodiment; and

FIG. 16 is a conceptual diagram illustrating an example of processing content of a processor according to the sixth embodiment.

### DETAILED DESCRIPTION

Hereinafter, an example of embodiments of an imaging support device, an imaging apparatus, an imaging support method, and a program according to the disclosed technology will be described with reference to the accompanying drawings.

First, terms used in the following description will be described.

CPU refers to the abbreviation for “Central Processing Unit”. GPU refers to the abbreviation for “Graphics Processing Unit”. TPU refers to the abbreviation for “Tensor Processing Unit”. HDD refers to the abbreviation for “Hard Disk Drive”. SSD refers to the abbreviation for “Solid State Drive”. RAM refers to the abbreviation for “Random Access Memory”. NVM refers to the abbreviation for “Non-Volatile Memory”. ASIC refers to the abbreviation for “Application Specific Integrated Circuit”. FPGA refers to the abbreviation for “Field-Programmable Gate Array”. PLD refers to the abbreviation for “Programmable Logic Device”. CMOS refers to the abbreviation for “Complementary Metal Oxide Semiconductor”. CCD refers to the abbreviation for “Charge Coupled Device”. SoC refers to the abbreviation for “System-on-a-Chip”. UI refers to the abbreviation for “User Interface”. EL refers to an abbreviation for “Electro Luminescence”.

In description of the present specification, the term “perpendicular” refers to not only being completely perpendicular but also being perpendicular in a sense generally allowed in the technical field of the disclosed technology, including an error not contradicting the gist of the disclosed technology. In the description of the present specification, the term “orthogonal” refers to not only being completely orthogonal but also being orthogonal in a sense generally allowed in the technical field of the disclosed technology, including an error not contradicting the gist of the disclosed technology. In description of the present specification, the term “match” refers to not only complete matching but also matching in a sense generally allowed in the technical field of the disclosed technology, including an error not contradicting the gist of the disclosed technology.

### First Embodiment

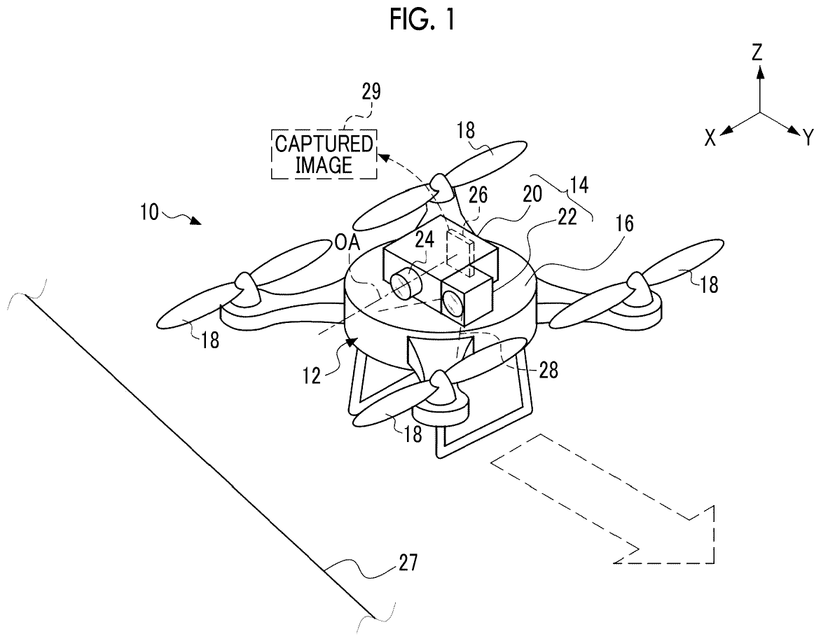

For example, as illustrated in FIG. 1, an imaging system 10 comprises a moving object 12 and an imaging apparatus 14. The imaging system 10 is connected to and capable of wirelessly communicating with a communication device (not illustrated), and various types of information are wirelessly exchanged between the imaging system 10 and the communication device. Operation of the imaging system 10 is controlled by the communication device.

Examples of the moving object 12 include an unmanned moving object. In the example illustrated in FIG. 1, an unmanned aerial vehicle (for example, a drone) is illustrated as an example of the moving object 12. While examples of the moving object 12 include an unmanned aerial vehicle, the disclosed technology is not limited to this. For example, the moving object 12 may be a vehicle. Examples of the vehicle include a vehicle equipped with a gondola, an aerial work platform, or a bridge inspection vehicle. The moving object 12 may be a slider, a cart, or the like on which the imaging apparatus 14 can be mounted. The moving object 12 may be a person. In this case, for example, the person refers to a worker who carries the imaging apparatus 14 and performs a survey and/or inspection of a land and/or an infrastructure by operating the imaging apparatus 14.

The moving object 12 comprises a body 16 and a plurality of propellers 18 (in the example illustrated in FIG. 1, four propellers). The moving object 12 flies or hovers in a three-dimensional space by controlling rotation of the plurality of propellers 18.

The imaging apparatus 14 is attached to the body 16. In the example illustrated in FIG. 1, the imaging apparatus 14 is attached to an upper portion of the body 16. However, this is merely an example, and the imaging apparatus 14 may be attached to a location (for example, a lower portion of the body 16) other than the upper portion of the body 16.

An X axis, a Y axis, and a Z axis are defined in the imaging system 10. The X axis is an axis along a forward-rearward direction of the moving object 12. The Y axis is an axis along a leftward-rightward direction of the moving object 12. The Z axis is an axis along a vertical direction, that is, an axis perpendicular to the X axis and the Y axis. Hereinafter, a direction along the X axis will be referred to as an X direction, a direction along the Y axis will be referred to as a Y direction, and a direction along the Z axis will be referred to as a Z direction.

Hereinafter, for convenience of description, one direction of the X axis (that is, the forward direction of the moving object 12) will be referred to as a +X direction, and the other direction of the X axis (that is, the rearward direction of the moving object 12) will be referred to as a −X direction. One direction of the Y axis (that is, the rightward direction of the moving object 12 in a front view) will be referred to as a +Y direction, and the other direction of the Y axis (that is, the leftward direction of the moving object 12 in a front view) will be referred to as a −Y direction.

One direction of the Z axis (that is, an upward direction of the moving object 12) will be referred to as a +Z direction, and the other direction of the Z axis (that is, a downward direction of the moving object 12) will be referred to as a −Z direction.

The imaging apparatus 14 comprises an imaging apparatus body 20 and an illumination device 22. The imaging apparatus 14 is an example of the “imaging apparatus” according to the disclosed technology, and the illumination device 22 is an example of an “illumination device” according to the disclosed technology.

The imaging apparatus body 20 comprises an imaging lens 24 and an image sensor 26. Examples of the imaging lens 24 include an interchangeable lens. Examples of the image sensor 26 include a CMOS image sensor.

While examples of the imaging lens 24 include an interchangeable lens, this is merely an example, and the imaging lens 24 may be a non-interchangeable lens. While examples of the image sensor 26 include a CMOS image sensor, this is merely an example, and thei image sensor 26 may be another type of image sensor (for example, a CCD image sensor).

The imaging lens 24 has an optical axis OA matching the X axis. A center of the image sensor 26 is positioned on the optical axis OA of the imaging lens 24. The imaging lens 24 receives subject light that is light indicating a subject 27, and forms an image of the received subject 27 on the image sensor 26. The image sensor 26 receives the subject light and images the subject 27 by photoelectrically converting the received subject light.

The illumination device 22 is disposed on a side in the +Y direction of the imaging apparatus body 20. The illumination device 22 is used for imaging using the image sensor 26 and emits supplementary light 28. The supplementary light 28 is light for supplementing an insufficient light quantity during imaging performed by the image sensor 26 and is emitted to a side closer to the subject 27. Reflected light obtained by reflection, on the subject 27, of the supplementary light 28 emitted from the illumination device 22 is received and photoelectrically converted by the image sensor 26. Accordingly, a captured image 29 is generated by the image sensor 26. The captured image 29 is brighter than that in a case where the supplementary light 28 is not emitted to the side closer to the subject 27. The supplementary light 28 is an example of “supplementary light” according to the disclosed technology.

The imaging apparatus 14 moves in the same direction (in the example illustrated in FIG. 1, the +Y direction) as a flying direction of the moving object 12 and images the subject 27 at each of a plurality of designated positions (for example, a plurality of waypoints). Examples of the subject 27 imaged by the imaging apparatus 14 include a land and/or an infrastructure. Examples of the infrastructure include a road facility (for example, a bridge, a road surface, a tunnel, a guard rail, a traffic light, and/or a windbreak), an irrigation facility, an airport facility, a harbor facility, a water storage facility, a gas facility, a power supply facility, a medical facility, and/or firefighting facility.

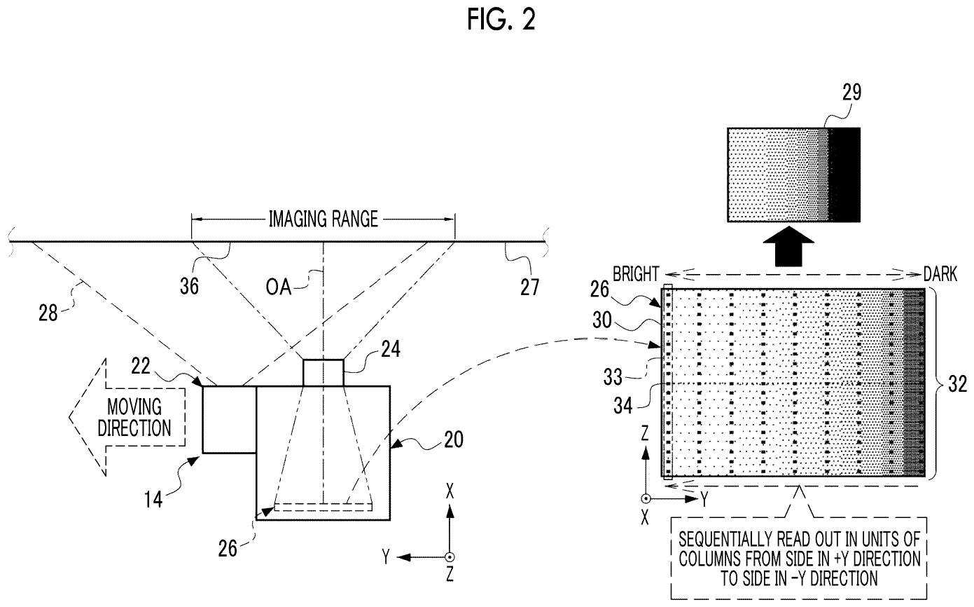

For example, as illustrated in FIG. 2, the imaging apparatus 14 emits the supplementary light 28 to the side closer to the subject 27 from the illumination device 22 and, in this state, images an imaging range 36 in the subject 27. The imaging range 36 is a range determined from an angle of view set for the imaging apparatus body 20.

The image sensor 26 comprises a photoelectric conversion element 30. The photoelectric conversion element 30 includes a photoelectric conversion region 32. A plurality of pixels 34 forms the photoelectric conversion region 32. The plurality of pixels 34 are disposed two-dimensionally (that is, in a matrix). Each pixel 34 includes a color filter, a photodiode, a capacitor, and the like. The pixel 34 receives the subject light, generates an analog image signal by performing photoelectric conversion on the received subject light, and outputs the generated analog image signal. The analog image signal is an electrical signal having a signal level corresponding to a received quantity of light received by the photodiode of the pixel 34. The photoelectric conversion region 32 is an example of a “photoelectric conversion region” according to the disclosed technology, and the plurality of pixels 34 are an example of a “plurality of pixels” according to the disclosed technology. For convenience of illustration, the number of pixels 34 in the photoelectric conversion region 32 in the example illustrated in FIG. 2 is smaller than the actual number of pixels 34. For example, the actual number of pixels in the photoelectric conversion region 32 is several million to several ten million.

The photoelectric conversion region 32 includes a plurality of pixel columns 33. The plurality of pixel columns 33 are obtained by dividing the photoelectric conversion region 32 into a plurality of columns along the +Y direction. The pixel column 33 is a region in which the plurality of pixels 34 are linearly arranged in the Z direction that is a direction intersecting with the Y direction. The pixel column 33 is formed by disposing the plurality of pixels 34 at equal intervals along the Z direction. The plurality of pixel columns 33 are disposed at equal intervals along the Y direction. The analog image signals are read out from the photoelectric conversion region 32 in units of pixel columns 33 from a side in the +Y direction to a side in the −Y direction. The plurality of pixel columns 33 are an example of a “plurality of divided regions” according to the disclosed technology.

In a case where the imaging range 36 in the subject 27 is imaged by the image sensor 26, an incidence ray on the photoelectric conversion region 32 causes a difference in brightness along the Y direction in the photoelectric conversion region 32. For example, the incidence ray on the photoelectric conversion region 32 refers to light including the reflected light obtained by reflection, on the subject 27, of the supplementary light 28 emitted from the illumination device 22.

In the example illustrated in FIG. 2, the supplementary light 28 is emitted to the imaging range 36 positioned in front of the imaging apparatus body 20 from the illumination device 22 disposed on the side in the +Y direction of the imaging apparatus body 20. Thus, a difference in brightness occurs along the Y direction in the imaging range 36. That is, a light distribution characteristic of the supplementary light 28 causes a difference in brightness such as brightness on a side closer to the illumination device 22 and darkness on a side farther from the illumination device 22 in the imaging range 36. The difference in brightness occurring in the imaging range 36 is also reflected in the photoelectric conversion region 32. In the example illustrated in FIG. 2, the incidence ray on the photoelectric conversion region 32 causes the photoelectric conversion region 32 to gradually darken from the side in the +Y direction to the side in the −Y direction. The Y direction is an example of “one direction” according to the disclosed technology.

In a case where the imaging range 36 is imaged by the image sensor 26 in a state where a difference in brightness occurs along the Y direction in the photoelectric conversion region 32, the same difference in brightness also appears in the captured image 29. Then, for example, in a case where a location to be checked such as a scratch (for example, a crack), rust, and/or liquid leakage in the subject 27 is detected by performing image recognition processing on the captured image 29, the difference in brightness included in the captured image 29 may decrease detection accuracy of the location to be checked.

Therefore, in view of such circumstances, exposure time control processing is performed by the imaging apparatus 14 in a first embodiment. The exposure time control processing is processing of performing a control of reducing an exposure time from the pixel column 33 on a darker side to the pixel column 33 on a brighter side of the plurality of pixel columns 33 (for example, all pixel columns 33) in the photoelectric conversion region 32, in a case where the incidence ray on the photoelectric conversion region 32 causes a difference in brightness along the Y direction in the photoelectric conversion region 32. Hereinafter, this will be described in more detail.

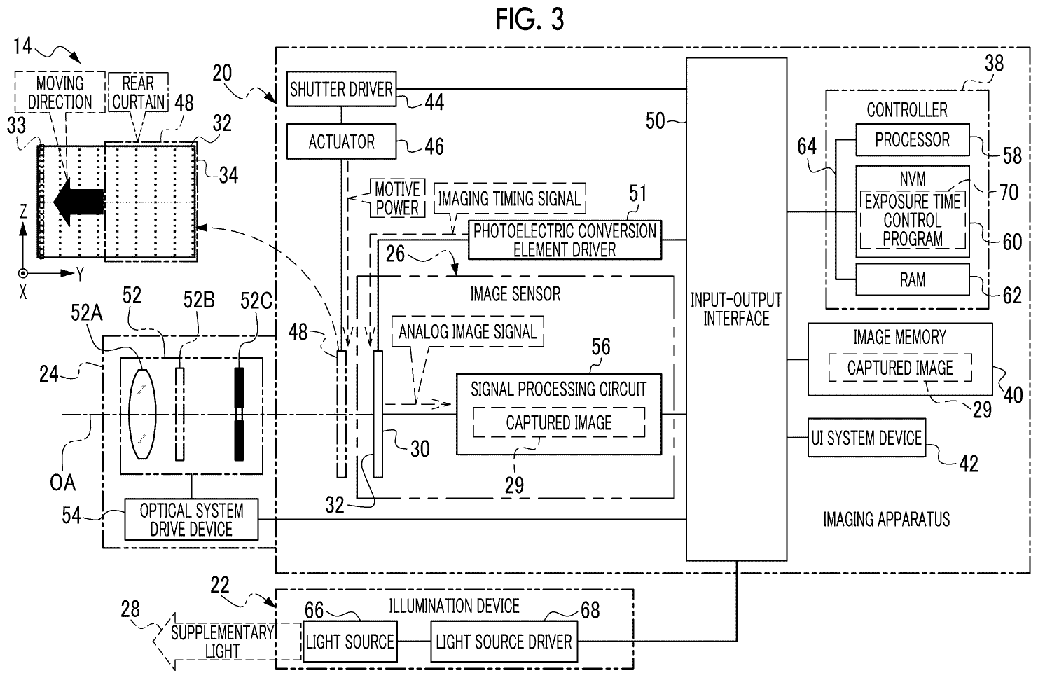

For example, as illustrated in FIG. 3, the imaging apparatus body 20 comprises the image sensor 26, a controller 38, an image memory 40, a UI system device 42, a shutter driver 44, an actuator 46, a focal-plane shutter 48, and a photoelectric conversion element driver 51. The imaging lens 24 comprises an optical system 52 and an optical system drive device 54. The image sensor 26 comprises a signal processing circuit 56 in addition to the photoelectric conversion element 30.

The controller 38, the image memory 40, the UI system device 42, the shutter driver 44, the photoelectric conversion element driver 51, the optical system drive device 54, and the signal processing circuit 56 are connected to an input-output interface 50.

The controller 38 comprises a processor 58, an NVM 60, and a RAM 62. The input-output interface 50, the processor 58, the NVM 60, and the RAM 62 are connected to a bus 64. The controller 38 is an example of an “imaging support device” and a “computer” according to the disclosed technology, and the processor 58 is an example of a “processor” according to the disclosed technology.

The processor 58 includes a CPU and a GPU. The GPU operates under control of the CPU and mainly executes image processing. The processor 58 may be one or more CPUs integrated with GPU functions or may be one or more CPUs not integrated with GPU functions. The processor 58 may include a multicore CPU or may include a TPU.

The NVM 60 is a non-volatile storage device storing various programs, various parameters, and the like. Examples of the NVM 60 include a flash memory (for example, an EEPROM) and/or an SSD. The flash memory and the SSD are merely examples, and the NVM 60 may be another non-volatile storage device such as an HDD or a combination of two or more types of non-volatile storage devices.

The RAM 62 is a memory temporarily storing information and is used as a work memory by the processor 58.

The processor 58 reads out a required program from the NVM 60 and executes the read program on the RAM 62. The processor 58 controls the entire imaging apparatus 14 in accordance with the program executed on the RAM 62.

The optical system 52 in the imaging lens 24 comprises a zoom lens 52A, a lens shutter 52B, and a stop 52C. The optical system 52 is connected to the optical system drive device 54, and the optical system drive device 54 operates the optical system 52 (for example, the zoom lens 52A, the lens shutter 52B, and the stop 52C) under control of the processor 58.

The focal-plane shutter 48 is disposed between the optical system 52 and the photoelectric conversion region 32. The focal-plane shutter 48 includes a front curtain and a rear curtain. The front curtain and the rear curtain of the focal-plane shutter 48 are mechanically connected to the actuator 46. The actuator 46 includes a motive power source (for example, a solenoid). The shutter driver 44 is connected to the actuator 46 and controls the actuator 46 in accordance with an instruction from the processor 58. The actuator 46 generates motive power under control of the shutter driver 44 and controls opening and closing of the front curtain and the rear curtain of the focal-plane shutter 48 by selectively applying the generated motive power to the front curtain and the rear curtain of the focal-plane shutter 48.

In a case where general exposure using the focal-plane shutter 48 is performed on the photoelectric conversion region 32, for example, the front curtain and the rear curtain of the focal-plane shutter 48 move from the side in the +Y direction to the side in the −Y direction. The front curtain starts moving earlier than the rear curtain. The front curtain before starting the exposure is fully closed, and in a case where an exposure start timing is reached, is fully opened by moving from the side in the +Y direction to the side in the −Y direction. Meanwhile, the rear curtain before starting the exposure is fully open, and in a case where the exposure start timing is reached, is fully closed by moving from the side in the +Y direction to the side in the −Y direction. The exposure time of the pixel column 33 is controlled using a width of a gap generated between the front curtain and the rear curtain and a shutter speed of the focal-plane shutter 48.

The photoelectric conversion element driver 51 is connected to the photoelectric conversion element 30. The photoelectric conversion element driver 51 supplies an imaging timing signal defining a timing of imaging performed by the photoelectric conversion element 30, to the photoelectric conversion element 30 in accordance with an instruction from the processor 58. The photoelectric conversion element 30 performs reset, exposure, and output of the analog image signal in accordance with the imaging timing signal supplied from the photoelectric conversion element driver 51. Examples of the imaging timing signal include a vertical synchronization signal and a horizontal synchronization signal.

An image of the subject light incident on the imaging lens 24 is formed in the photoelectric conversion region 32 by the imaging lens 24. The photoelectric conversion element 30, under control of the photoelectric conversion element driver 51, photoelectrically converts the subject light received in the photoelectric conversion region 32 and outputs an electrical signal corresponding to a quantity of the subject light to the signal processing circuit 56 as the analog image signal indicating the subject light. Specifically, the signal processing circuit 56 reads out the analog image signal from the photoelectric conversion element 30 in units of frames for each pixel column 33 using a line exposure sequential readout system.

The signal processing circuit 56 generates the captured image 29 by converting the analog image signal input from the photoelectric conversion element 30 into a digital form, and stores the generated captured image 29 in the image memory 40. The processor 58 acquires the captured image 29 from the image memory 40 and performs various types of processing using the acquired captured image 29.

The UI system device 42 comprises a display device and a reception device. Examples of the display device include an EL display or a liquid crystal display. Examples of the reception device include a touch panel, a hard key, and/or a dial. The processor 58 operates in accordance with various instructions received by the UI system device 42. The processor 58 displays results of various types of processing on the UI system device 42.

The illumination device 22 comprises a light source 66 and a light source driver 68. The light source driver 68 is connected to the light source 66. The light source driver 68 is connected to the input-output interface 50 and controls the light source 66 in accordance with an instruction from the processor 58. The light source 66 emits visible light (for example, white light) under control of the light source driver 68. The visible light emitted from the light source 66 is emitted to the side closer to the subject 27 (refer to FIGS. 1 and 2) as the supplementary light 28.

An exposure time control program 70 is stored in the NVM 60. The processor 58 reads out the exposure time control program 70 from the NVM 60 and executes the read exposure time control program 70 on the RAM 62. The exposure time control processing is implemented by executing the exposure time control program 70 via the processor 58 on the RAM 62. The exposure time control program 70 is an example of a “program” according to the disclosed technology.

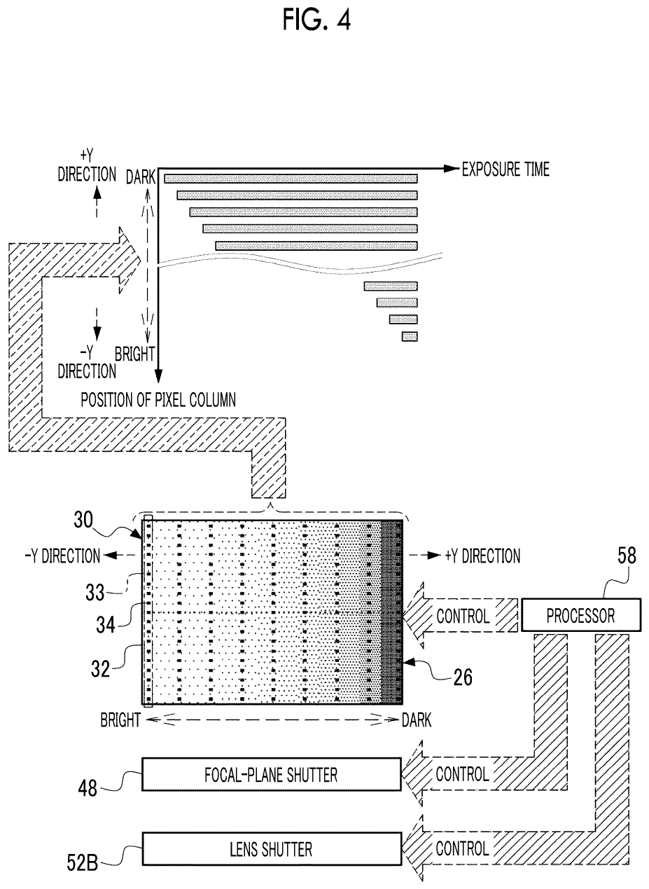

For example, as illustrated in FIG. 4, in the exposure time control processing, the focal-plane shutter 48 and the lens shutter 52B are used for imaging using the image sensor 26. In the exposure time control processing, the processor 58 resets the photoelectric conversion element 30 before starting the exposure and outputs the analog image signal from each pixel column 33 after the exposure. In the exposure time control processing, the processor 58 controls the exposure time of the photoelectric conversion region 32 by controlling the focal-plane shutter 48 and the lens shutter 52B. The focal-plane shutter 48 and the lens shutter 52B are examples of a “mechanical shutter” according to the disclosed technology.

The processor 58 reduces the exposure time from the pixel column 33 on the darker side to the pixel column 33 on the brighter side of the plurality of pixel columns 33 (for example, all pixel columns 33) by controlling the exposure start timing and an exposure end timing for the plurality of pixel columns 33. In the example illustrated in FIG. 4, the darker side of the plurality of pixel columns 33 refers to the side in the +Y direction, and the brighter side of the plurality of pixel columns 33 refers to the side in the −Y direction.

In the first embodiment, the exposure time of each pixel column 33 is determined in advance based on a feature of the difference in brightness appearing in the photoelectric conversion region 32. There are various determination methods of the exposure time, and a determination method according to the disclosed technology will be described from a second embodiment.

Each pixel column 33 is exposed for the exposure time determined in advance. The exposure start timing and the exposure end timing for the plurality of pixel columns 33 are determined by the processor 58 in accordance with the exposure time determined in advance for each pixel column 33.

As a control for reducing the exposure time from the pixel column 33 on the darker side to the pixel column 33 on the brighter side of the plurality of pixel columns 33, the processor 58 performs a control of delaying the exposure start timing for the plurality of pixel columns 33 from the pixel column 33 on the darker side to the pixel column 33 on the brighter side of the plurality of pixel columns 33 and matching the exposure end timing for the plurality of pixel columns 33.

In this case, for example, first, the processor 58 sets a position of the mechanical shutter to an initial position. An initial position of the focal-plane shutter 48 in a case where the exposure time control processing is performed refers to a position at which the rear curtain is fully opened and the front curtain is fully closed. An initial position of the lens shutter 52B in a case where the exposure time control processing is performed refers to a position at which the lens shutter 52B is fully opened.

Next, the processor 58 fully opens the front curtain of the focal-plane shutter 48 by moving the front curtain of the focal-plane shutter 48 at a first shutter speed from the darker side to the brighter side of the plurality of pixel columns 33. The exposure start timing for the plurality of pixel columns 33 is defined based on the first shutter speed. The first shutter speed is determined by the processor 58 in accordance with the exposure time determined in advance for each pixel column 33. For example, the first shutter speed is derived from an operation expression that takes the exposure time applied to the pixel column 33 as an independent variable and that takes the first shutter speed as a dependent variable, or a table in which the exposure time applied to the pixel column 33 and the first shutter speed are associated with each other.

In a case where the front curtain of the focal-plane shutter 48 is fully opened as described above, the processor 58 performs a control of matching the exposure end timing for the plurality of pixel columns 33 using a global shutter system with the lens shutter 52B. That is, the processor 58 operates the lens shutter 52B at a timing at which the front curtain of the focal-plane shutter 48 is fully opened. Accordingly, the lens shutter 52B is fully closed, and the subject light is blocked by the lens shutter 52B. Thus, the exposure of the photoelectric conversion region 32 is finished.

At a timing at which the exposure of the photoelectric conversion region 32 is finished, the processor 58 outputs the analog image signal to the signal processing circuit 56 from each pixel column 33 by controlling the photoelectric conversion element 30.

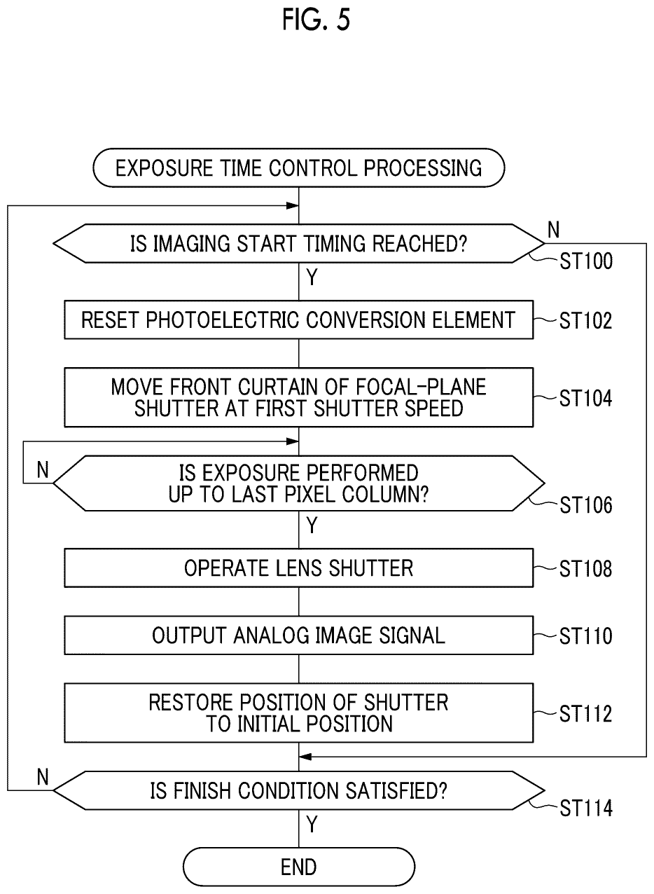

Next, an action of the imaging system 10 according to the first embodiment will be described with reference to FIG. 5. FIG. 5 illustrates an example of a flow of the exposure time control processing executed by the processor 58. The flow of the exposure time control processing illustrated in FIG. 5 is an example of an “imaging support method” according to the disclosed technology.

The description here assumes that the supplementary light 28 is emitted to the side closer to the subject 27 from the illumination device 22. The description here assumes that the position of the mechanical shutter is the initial position.

In the exposure time control processing illustrated in FIG. 5, first, in step ST100, the processor 58 determines whether or not a timing at which imaging starts via the image sensor 26 is reached. A first example of the timing at which imaging starts is a condition that the imaging system 10 reaches a predetermined position (for example, a waypoint) and the photoelectric conversion region 32 faces the imaging range 36. A second example of the timing at which imaging starts is a condition that an instruction to start imaging is provided to the imaging apparatus 14 from an outside (for example, the communication device).

In step ST100, in a case where the timing at which imaging starts via the image sensor 26 is not reached, a negative determination is made, and the exposure time control processing transitions to step ST114. In step ST100, in a case where the timing at which imaging starts via the image sensor 26 is reached, a positive determination is made, and the exposure time control processing transitions to step ST102.

In step ST102, the processor 58 resets the photoelectric conversion element 30. After the processing in step ST102 is executed, the exposure time control processing transitions to step ST104.

In step ST104, the processor 58 moves the front curtain of the focal-plane shutter 48 at the first shutter speed from the darker side to the brighter side of the plurality of pixel columns 33. After the processing in step ST104 is executed, the exposure time control processing transitions to step ST106.

In step ST106, the processor 58 determines whether or not the first pixel column 33 to the last pixel column 33 are exposed. A case where the first pixel column 33 to the last pixel column 33 are exposed refers to a case where the front curtain of the focal-plane shutter 48 is fully closed. In step ST106, in a case where the first pixel column 33 to the last pixel column 33 are not exposed, a negative determination is made, and the determination in step ST106 is performed again. In step ST106, in a case where the first pixel column 33 to the last pixel column 33 are exposed, a positive determination is made, and the exposure time control processing transitions to step ST108.

In step ST108, the processor 58 operates the lens shutter 52B. Accordingly, the lens shutter 52B is fully closed, and the subject light is blocked by the lens shutter 52B. Thus, the exposure of the photoelectric conversion region 32 is finished. By executing the processing in steps ST102 to ST108, the exposure time is reduced in order from the pixel column 33 on the darker side to the pixel column 33 on the brighter side of the plurality of pixel columns 33. After the processing in step ST108 is executed, the exposure time control processing transitions to step ST110.

In step ST110, the processor 58 outputs the analog image signal to the signal processing circuit 56 from each pixel column 33 by controlling the photoelectric conversion element 30. After the processing in step ST110 is executed, the exposure time control processing transitions to step ST112.

In step ST112, the processor 58 restores the position of the mechanical shutter to the initial position by controlling the mechanical shutter. After the processing in step ST112 is executed, the exposure time control processing transitions to step ST114.

In step ST114, the processor 58 determines whether or not a condition for finishing the exposure time control processing is satisfied. A first example of the condition for finishing the exposure time control processing is a condition that the imaging system 10 has performed imaging at all predetermined positions (for example, all waypoints). A second example of the condition for finishing the exposure time control processing is a condition that an instruction to finish the exposure time control processing is provided to the imaging apparatus 14 from the outside (for example, the communication device).

In step ST114, in a case where the condition for finishing the exposure time control processing is not satisfied, a negative determination is made, and the exposure time control processing transitions to step ST100. In step ST114, in a case where the condition for finishing the exposure time control processing is satisfied, a positive determination is made, and the exposure time control processing is finished.

As described above, in a case where the imaging range 36 in the subject 27 is imaged by the image sensor 26, the supplementary light 28 is emitted to the imaging range 36 positioned in front of the imaging apparatus body 20 from the illumination device 22 disposed on the side in the +Y direction of the imaging apparatus body 20. Thus, a difference in brightness occurs along the Y direction in the imaging range 36. That is, a difference in brightness such as brightness on a side closer to the illumination device 22 and darkness on a side farther from the illumination device 22 occurs in the imaging range 36. The difference in brightness occurring in the imaging range 36 is also reflected in the photoelectric conversion region 32. That is, the incidence ray on the photoelectric conversion region 32 causes the photoelectric conversion region 32 to gradually darken from the side in the +Y direction to the side in the −Y direction.

Therefore, in the imaging system 10 according to the first embodiment, in a case where the incidence ray on the photoelectric conversion region 32 causes a difference in brightness along the Y direction in the photoelectric conversion region 32, the control of reducing the exposure time from the pixel column 33 on the darker side to the pixel column 33 on the brighter side of the plurality of pixel columns 33 in the photoelectric conversion region 32 is performed. Accordingly, even in a case where the incidence ray on the photoelectric conversion region 32 causes a difference in brightness along the Y direction in the photoelectric conversion region 32, the image sensor 26 can generate the captured image 29 having little brightness unevenness. Consequently, for example, a decrease in the detection accuracy in a case where the location to be checked such as a scratch, rust, and/or liquid leakage in the subject 27 is detected by performing image recognition processing on the captured image 29 can be suppressed.

In the imaging system 10 according to the first embodiment, a column in which the plurality of pixels 34 are linearly arranged in the Z direction that is a direction intersecting with the Y direction is used as the pixel column 33. In a case where the incidence ray on the photoelectric conversion region 32 causes a difference in brightness along the Y direction in the photoelectric conversion region 32, the control of reducing the exposure time from the pixel column 33 on the darker side to the pixel column 33 on the brighter side of the plurality of pixel columns 33 in the photoelectric conversion region 32 is performed. Accordingly, even in a case where a difference in brightness occurs along the Y direction that is a direction traversing the plurality of pixel columns 33, the image sensor 26 can generate the captured image 29 having little brightness unevenness.

In the imaging system 10 according to the first embodiment, light including the reflected light obtained by reflection, on the subject 27, of the supplementary light 28 emitted from the illumination device 22 is incident on the photoelectric conversion region 32 and causes a difference in brightness along the Y direction in the photoelectric conversion region 32. In this case, the control of reducing the exposure time from the pixel column 33 on the darker side to the pixel column 33 on the brighter side of the plurality of pixel columns 33 in the photoelectric conversion region 32 is performed. Accordingly, even in a case where light including the reflected light obtained by reflection, on the subject 27, of the supplementary light 28 emitted from the illumination device 22 is incident on the photoelectric conversion region 32 and causes a difference in brightness along the Y direction in the photoelectric conversion region 32, the image sensor 26 can generate the captured image 29 having little brightness unevenness.

In the imaging system 10 according to the first embodiment, in a case where the incidence ray on the photoelectric conversion region 32 causes a difference in brightness along the Y direction in the photoelectric conversion region 32, the control of reducing the exposure time from the pixel column 33 on the darker side to the pixel column 33 on the brighter side of the plurality of pixel columns 33 in the photoelectric conversion region 32 is performed using the mechanical shutter. Accordingly, even in a case where the incidence ray on the photoelectric conversion region 32 of the imaging apparatus 14 not equipped with an electronic shutter causes a difference in brightness along the Y direction in the photoelectric conversion region 32, the image sensor 26 can generate the captured image 29 having little brightness unevenness.

In the imaging system 10 according to the first embodiment, the processor 58 reduces the exposure time from the pixel column 33 on the darker side to the pixel column 33 on the brighter side of the plurality of pixel columns 33 by controlling the exposure start timing and the exposure end timing for the plurality of pixel columns 33. For example, the processor 58 performs the control of delaying the exposure start timing for the plurality of pixel columns 33 from the pixel column 33 on the darker side to the pixel column 33 on the brighter side of the plurality of pixel columns 33 and matching the exposure end timing for the plurality of pixel columns 33. Accordingly, an exposure amount can be easily reduced from the pixel column 33 on the darker side to the pixel column 33 on the brighter side of the plurality of pixel columns 33, compared to that in adjusting the incidence ray on the photoelectric conversion region 32.

In the imaging system 10 according to the first embodiment, the processor 58 performs the control of matching the exposure end timing for the plurality of pixel columns 33 using the global shutter system with the lens shutter 52B. Accordingly, the exposure end timing for the plurality of pixel columns 33 can be easily matched, compared to that in performing a control of matching the exposure end timing using only a rolling shutter system.

The first embodiment describes an example of matching the exposure end timing for the plurality of pixel columns 33 using the global shutter system with the mechanical shutter (for example, the global shutter system with the lens shutter 52B). However, the disclosed technology is not limited to this. For example, the exposure end timing for the plurality of pixel columns 33 may be matched using a fully electronic shutter (that is, an electronic shutter) with the image sensor 26, as a global shutter together with the lens shutter 52B or instead of the lens shutter 52B.

The first embodiment describes an example of moving the front curtain of the focal-plane shutter 48 at the first shutter speed from the darker side to the brighter side. However, the disclosed technology is not limited to this. For example, an electronic front curtain shutter may be used instead of the front curtain of the focal-plane shutter 48. In this case, the electronic front curtain shutter may be moved at the first shutter speed from the darker side to the brighter side in a state where the front curtain and the rear curtain of the focal-plane shutter 48 are fully opened.

The first embodiment describes an example of performing, via the processor 58, the control of delaying the exposure start timing for the plurality of pixel columns 33 from the pixel column 33 on the darker side to the pixel column 33 on the brighter side of the plurality of pixel columns 33 and matching the exposure end timing for the plurality of pixel columns 33, as the control for reducing the exposure time from the pixel column 33 on the darker side to the pixel column 33 on the brighter side of the plurality of pixel columns 33. However, the disclosed technology is not limited to this.

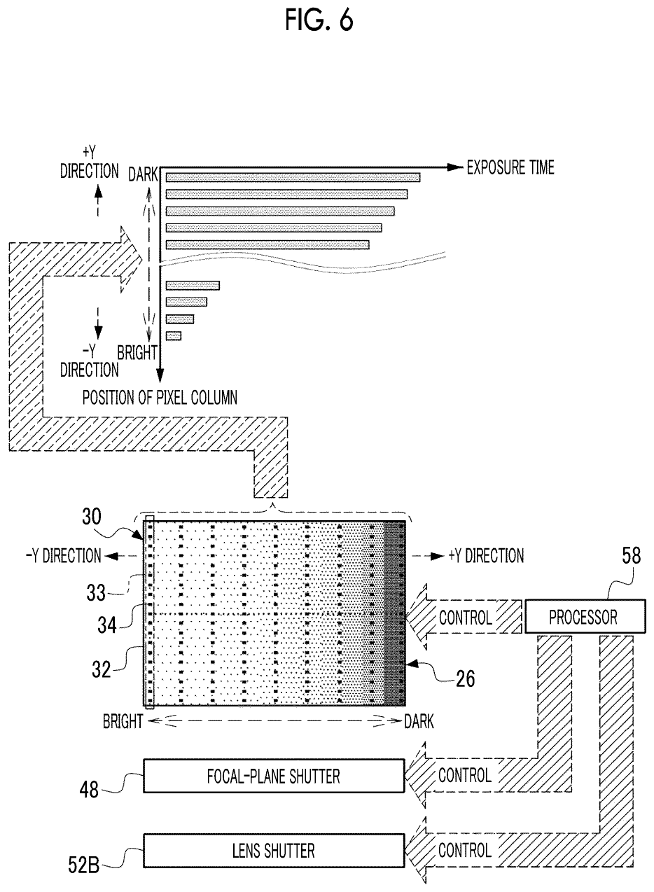

For example, as illustrated in FIG. 6, the processor 58 may perform a control of matching the exposure start timing for the plurality of pixel columns 33 and delaying the exposure end timing for the plurality of pixel columns 33 from the pixel column 33 on the brighter side to the pixel column 33 on the darker side of the plurality of pixel columns 33. Even in this case, the exposure start timing for the plurality of pixel columns 33 may be matched in the same manner as in matching the exposure end timing in the first embodiment. That is, the processor 58 may match the exposure start timing for the plurality of pixel columns 33 using the global shutter system with the mechanical shutter (for example, the global shutter system with the lens shutter 52B). The processor 58 may match the exposure start timing for the plurality of pixel columns 33 using the fully electronic shutter with the image sensor 26 as the global shutter.

The example illustrated in FIG. 3 describes an example of moving the rear curtain of the focal-plane shutter 48 from the side in the +Y direction to the side in the −Y direction. However, in delaying the exposure end timing for the plurality of pixel columns 33 from the pixel column 33 on the brighter side to the pixel column 33 on the darker side of the plurality of pixel columns 33, a moving direction of the focal-plane shutter 48 is reversed. That is, the focal-plane shutter 48 is disposed in a direction in which the rear curtain of the focal-plane shutter 48 is moved from the side in the −Y direction to the side in the +Y direction. The processor 58 performs a control of moving the rear curtain of the focal-plane shutter 48 at the first shutter speed from the brighter side to the darker side of the plurality of pixel columns 33, as a control of delaying the exposure end timing for the plurality of pixel columns 33 from the pixel column 33 on the brighter side to the pixel column 33 on the darker side of the plurality of pixel columns 33.

The same effect as the first embodiment can be achieved even in a case where the control of matching the exposure start timing for the plurality of pixel columns 33 and delaying the exposure end timing for the plurality of pixel columns 33 from the pixel column 33 on the brighter side to the pixel column 33 on the darker side of the plurality of pixel columns 33 is performed as the control for reducing the exposure time from the pixel column 33 on the darker side to the pixel column 33 on the brighter side of the plurality of pixel columns 33.

While an example of moving the rear curtain of the focal-plane shutter 48 at the first shutter speed from the brighter side to the darker side of the plurality of pixel columns 33 is described, the disclosed technology is not limited to this. For example, the exposure end timing for the plurality of pixel columns 33 may be delayed from the pixel column 33 on the brighter side to the pixel column 33 on the darker side of the plurality of pixel columns 33, by reading out the analog image signal sequentially from the pixel column 33 on the brighter side to the pixel column 33 on the darker side of the plurality of pixel columns 33 using the fully electronic shutter with the image sensor 26.

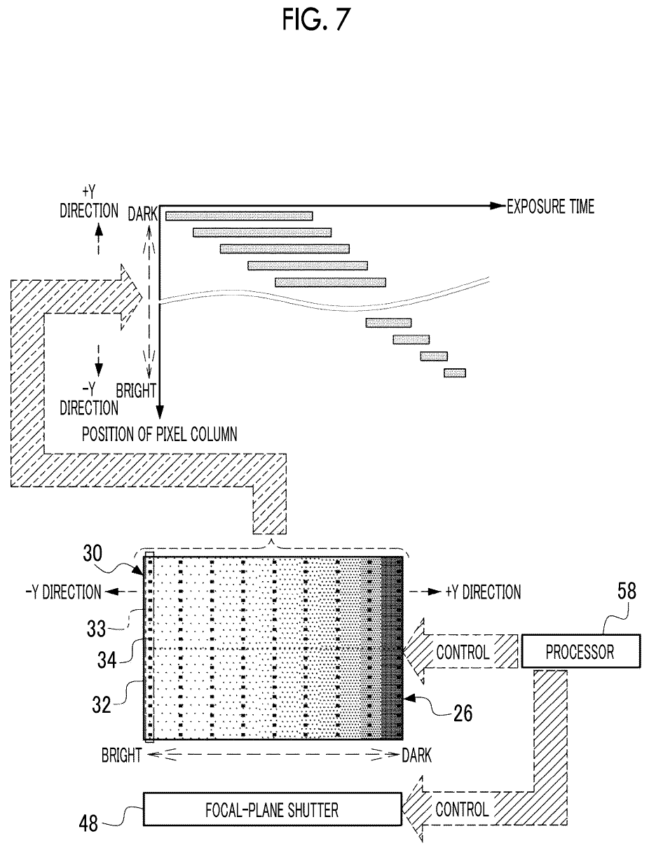

For example, as illustrated in FIG. 7, the processor 58 may perform a control of delaying the exposure start timing for the plurality of pixel columns 33 from the pixel column 33 on the darker side to the pixel column 33 on the brighter side of the plurality of pixel columns 33 and also delaying the exposure end timing for the plurality of pixel columns 33 from the pixel column 33 on the darker side to the pixel column 33 on the brighter side of the plurality of pixel columns 33. Even in this case, the processor 58 performs the control of reducing the exposure time from the darker side to the brighter side of the plurality of pixel columns 33.

In order to implement this, the processor 58 performs a control of delaying the exposure start timing for the plurality of pixel columns 33 from the pixel column 33 on the darker side to the pixel column 33 on the brighter side of the plurality of pixel columns 33, in the same manner as in the first embodiment. That is, the processor 58 moves the front curtain of the focal-plane shutter 48 at the first shutter speed from the darker side to the brighter side of the plurality of pixel columns 33 or operates the electronic front curtain shutter.

The processor 58 performs the control of delaying the exposure end timing for the plurality of pixel columns 33 from the pixel column 33 on the brighter side to the pixel column 33 on the darker side of the plurality of pixel columns 33, in the same manner as in the example illustrated in FIG. 6. In this case, the focal-plane shutter 48 for finishing the exposure is used. The focal-plane shutter 48 for finishing the exposure is a focal-plane shutter of which a rear curtain moves from the side in the −Y direction side to the side in the +Y direction side in a state where a front curtain is fully opened. The processor 58 performs a control of moving the rear curtain of the focal-plane shutter 48 for finishing the exposure at a second shutter speed from the brighter side to the darker side of the plurality of pixel columns 33.

In the example illustrated in FIG. 7, the exposure end timing for the plurality of pixel columns 33 is defined based on the second shutter speed. The second shutter speed is determined by the processor 58 in accordance with the exposure time determined in advance for each pixel column 33. For example, the second shutter speed is derived from an operation expression that takes the exposure time applied to the pixel column 33 as an independent variable and that takes the second shutter speed as a dependent variable, or a table in which the exposure time applied to the pixel column 33 and the second shutter speed are associated with each other.

The exposure time is reduced from the pixel column 33 on the darker side to the pixel column 33 on the brighter side of the plurality of pixel columns 33, by moving the front curtain of the focal-plane shutter 48 at the first shutter speed from the darker side to the brighter side of the plurality of pixel columns 33 and moving the rear curtain of the focal-plane shutter 48 for finishing the exposure at the second shutter speed from the brighter side to the darker side of the plurality of pixel columns 33. Accordingly, the same effect as the first embodiment can be achieved.

While the exposure time is reduced from the pixel column 33 on the darker side to the pixel column 33 on the brighter side of the plurality of pixel columns 33 by moving the focal-plane shutter 48, the disclosed technology is not limited to this. For example, the exposure time can be reduced from the pixel column 33 on the darker side to the pixel column 33 on the brighter side of the plurality of pixel columns 33 using the line exposure sequential readout system with the fully electronic shutter.

### Second Embodiment

The second embodiment describes an example of determining the exposure time of each pixel column 33 by performing exposure time determination processing via the imaging apparatus 14. In the second embodiment, constituents described in the first embodiment will be designated by the same reference numerals and will not be described, and different parts from the first embodiment will be described.

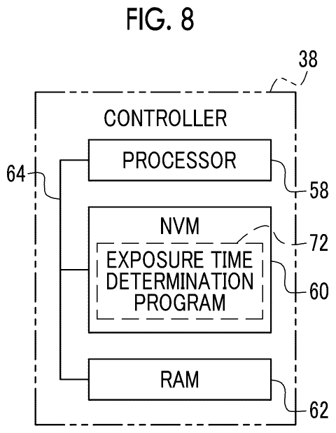

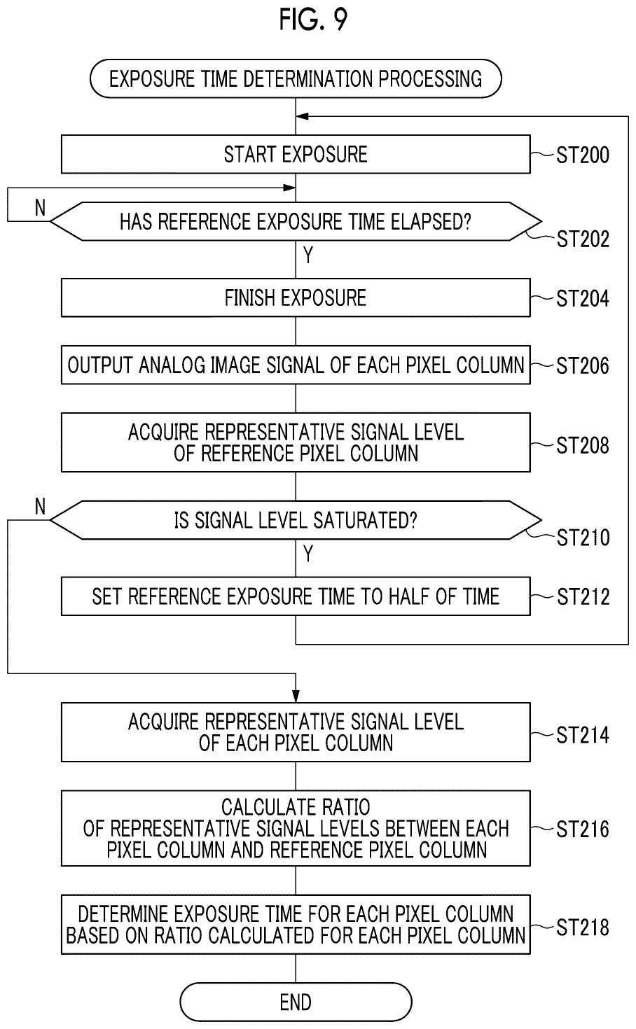

For example, as illustrated in FIG. 8, an exposure time determination program 72 is stored in the NVM 60. The processor 58 reads out the exposure time determination program 72 from the NVM 60 and executes the read exposure time determination program 72 on the RAM 62. The processor 58 performs the exposure time determination processing (refer to FIG. 9) in accordance with the exposure time determination program 72 executed on the RAM 62.

FIG. 9 illustrates an example of a flow of the exposure time determination processing performed by the processor 58 according to the second embodiment.

Description of the second embodiment assumes that the supplementary light 28 is emitted to the side closer to the subject 27 from the illumination device 22. Description of the second embodiment assumes that the exposure of the photoelectric conversion region 32 is performed by moving the front curtain and the rear curtain of the focal-plane shutter 48 along the Y direction (for example, from the brighter side to the darker side of the plurality of pixel columns 33) in a state where the front curtain and the rear curtain of the focal-plane shutter 48 are fully closed.

In the exposure time determination processing illustrated in FIG. 9, first, in step ST200, the processor 58 resets the photoelectric conversion element 30 and starts the exposure of the photoelectric conversion region 32 by operating the focal-plane shutter 48. After the processing in step ST200 is executed, the exposure time determination processing transitions to step ST202.

In step ST202, the processor 58 determines whether or not a reference exposure time has elapsed from execution of the processing in step ST200. The reference exposure time is an example of a “first reference exposure time” according to the disclosed technology. Examples of the reference exposure time include an exposure time determined in accordance with an instruction provided from the outside (for example, the communication device) or an instruction received by the UI system device 42. In step ST202, in a case where the reference exposure time has not elapsed from execution of the processing in step ST200, a negative determination is made, and the determination in step ST202 is performed again. In a case where the reference exposure time has elapsed after execution of the processing in step ST200, a positive determination is made, and the exposure time determination processing transitions to step ST204.

While an example of controlling the exposure of the photoelectric conversion region 32 via the processor 58 using the mechanical shutter is illustrated in steps ST200 to ST204, this is merely an example. For example, the exposure of the photoelectric conversion region 32 may be controlled by the processor 58 using the electronic shutter.

In step ST204, the processor 58 finishes the exposure of the photoelectric conversion region 32 by fully closing the rear curtain of the focal-plane shutter 48. After the processing in step ST204 is executed, the exposure time determination processing transitions to step ST206.

In step ST206, the processor 58 outputs the analog image signal from each pixel column 33. After the processing in step ST206 is executed, the exposure time determination processing transitions to step ST208.

In step ST208, the processor 58 acquires a representative signal level of a reference pixel column among all pixel columns 33. The reference pixel column is an example of a “first reference region in the photoelectric conversion region” according to the disclosed technology. For example, the reference pixel column refers to the pixel column 33 at a center of all pixel columns 33. While the pixel column 33 at the center of all pixel columns 33 is illustrated as the reference pixel column, this is merely an example, and the reference pixel column may be another pixel column 33 determined in advance or a plurality of pixel columns 33 positioned in a center portion of the photoelectric conversion region 32. Examples of the other pixel column 33 determined in advance include the pixel column 33 positioned on a brighter side with respect to the reference pixel column among all pixel columns 33 (for example, the pixel column 33 positioned at one end in the −Y direction among all pixel columns 33).

In the second embodiment, the representative signal level refers to an average value of the signal levels of the analog image signals output from all pixels 34 included in the pixel column 33. While the average value is described, this is merely an example, and a statistical value such as a median value or a mode value may be applied instead of the average value. After the processing in step ST208 is executed, the exposure time determination processing transitions to step ST210.

In step ST210, the processor 58 determines whether or not the representative signal level acquired in step ST208, that is, the representative signal level of the reference pixel column, is saturated. Saturation of the representative signal level of the reference pixel column means that the representative signal level of the reference pixel column is a signal level at which an image region based on the reference pixel column is washed out in the captured image 29. In step ST210, in a case where the representative signal level of the reference pixel column is not saturated, a negative determination is made, and the exposure time determination processing transitions to step ST214. In step ST210, in a case where the representative signal level of the reference pixel column is saturated, a positive determination is made, and the exposure time determination processing transitions to step ST212.

In step ST212, the processor 58 sets the reference exposure time to half of the time. After the processing in step ST212 is executed, the exposure time determination processing transitions to step ST200. By performing the processing in steps ST200 to ST212, the reference exposure time is adjusted to a time shorter than a time in which the representative signal level of the reference pixel column is saturated.

In step ST214, the processor 58 acquires the representative signal level of each pixel column 33 (for example, each of all pixel columns 33). After the processing in step ST214 is executed, the exposure time determination processing transitions to step ST216.

In step ST216, a ratio of the representative signal level between the representative signal level of each pixel column 33 and the representative signal level of the reference pixel column (hereinafter, simply referred to as the “ratio”) is calculated for each pixel column 33. The ratio refers to a ratio of the representative signal level of the pixel column 33 to the representative signal level of the reference pixel column. The ratio calculated in step ST216 is an example of a “first degree of difference” according to the disclosed technology. After the processing in step ST216 is executed, the exposure time determination processing transitions to step ST218.

In the photoelectric conversion region 32, the pixel column 33 of which a value of the ratio is less than 1 is darker than the reference pixel column, and the pixel column 33 of which the value of the ratio is greater than 1 is brighter than the reference pixel column. Therefore, in step ST218, the processor 58 determines the exposure time for each pixel column 33 based on the ratio calculated for each pixel column 33. For example, the processor 58 determines the exposure time such that the pixel column 33 of which the value of the ratio is less than 1 has a long exposure time, and the pixel column 33 of which the value of the ratio is greater than 1 has a short exposure time in the photoelectric conversion region 32. The exposure time is determined by deriving the exposure time from an operation expression that takes the ratio as an independent variable and that takes the exposure time of the pixel column 33 as a dependent variable, or a table in which the ratio and the exposure time of the pixel column 33 are associated with each other. While the exposure time of each pixel column 33 is determined in advance in the first embodiment, the exposure time determined in step ST218 may be applied as the exposure time of each pixel column 33. After the processing in step ST218 is executed, the exposure time determination processing is finished.

As described above, in the second embodiment, the exposure time for each pixel column 33 from the pixel column 33 on the darker side to the pixel column 33 on the brighter side of the plurality of pixel columns 33 in the photoelectric conversion region 32 is determined by the ratio of the representative signal level between the representative signal level of each pixel column 33 and the representative signal level of the reference pixel column. The ratio is determined for each pixel column 33. Each ratio is a value representing a degree of difference between the representative signal level of the reference pixel column and each representative signal level obtained from each pixel column 33 in a case where the exposure time of the photoelectric conversion region 32 is set to be shorter than the reference exposure time. Accordingly, a suitable exposure time (for example, an exposure time not causing brightness unevenness in the captured image 29 or an exposure time not causing overexposure) for each pixel column 33 from the pixel column 33 on the darker side to the pixel column 33 on the brighter side of the plurality of pixel columns 33 in the photoelectric conversion region 32 can be determined.

By performing the processing in steps ST200 to ST212 illustrated in FIG. 9, the reference exposure time is adjusted to a time shorter than a time period in which the signal level of the analog image signal output from the reference pixel column in the photoelectric conversion region 32 is saturated. Accordingly, the exposure time of the reference pixel column in the photoelectric conversion region 32 is set to be shorter than the time period in which the signal level of the analog image signal output from the reference pixel column is saturated. The exposure time of each pixel column 33 is determined with reference to the exposure time of the reference pixel column. Consequently, an exposure time that is unlikely to cause overexposure of each pixel column 33 can be set for each pixel column 33, compared to that in a case where an exposure time longer than or equal to the time in which the signal level of the analog image signal output from the reference pixel column is saturated is set for the reference pixel column in the photoelectric conversion region 32.

While the ratio is illustrated in the second embodiment, this is merely an example, and a difference between the representative signal level of the reference pixel column and the representative signal level of the pixel column 33 may be used instead of the ratio. In this case, the difference between the representative signal level of the reference pixel column and the representative signal level of the pixel column 33 is an example of the “first degree of difference” according to the disclosed technology.

The second embodiment describes an example of setting the reference exposure time to half of the time in a case where the representative signal level of the reference pixel column in the photoelectric conversion region 32 is saturated. However, this is merely an example. How much the reference exposure time is to be reduced in a case where the representative signal level of the reference pixel column in the photoelectric conversion region 32 is saturated may be appropriately determined in accordance with an instruction provided from the user or the like and/or an imaging condition or the like of the imaging apparatus 14.

The second embodiment describes an example of determining the exposure time for each pixel column 33 using the representative signal levels of all pixel columns 33, by performing the processing in steps ST214 to ST218 in the exposure time determination processing illustrated in FIG. 9. However, the disclosed technology is not limited to this. For example, the exposure times of several pixel columns 33 may be estimated using an interpolation method. In this case, first, two or more ratios are calculated from the representative signal level of the reference pixel column and the representative signal level of one or more pixel columns 33 other than the reference pixel column. Next, the exposure time of each corresponding pixel column 33 is determined based on the two or more ratios. The exposure times of the remaining pixel columns 33 may be estimated from a plurality of determined exposure times using the interpolation method.

### Third Embodiment

While the second embodiment describes an example of determining the exposure time for each pixel column 33 based on a determination result of whether or not the representative signal level of the reference pixel column in the photoelectric conversion region 32 is saturated, a third embodiment describes an example of determining the exposure time for each pixel column 33 based on a determination result of whether or not the representative signal level of each pixel column 33 falls within a reference range. In the third embodiment, constituents described in each embodiment will be designated by the same reference numerals and will not be described, and different parts from each embodiment will be described.

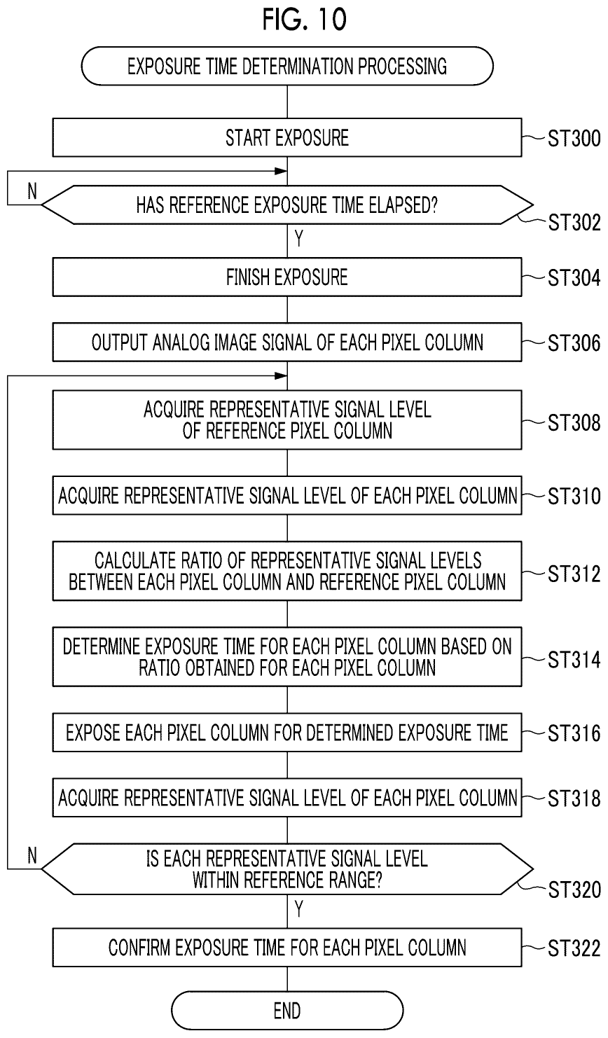

FIG. 10 illustrates an example of a flow of the exposure time determination processing performed by the processor 58 according to the third embodiment.

Description of the third embodiment assumes that the supplementary light 28 is emitted to the side closer to the subject 27 from the illumination device 22. Description of the third embodiment assumes that the exposure of the photoelectric conversion region 32 is performed by moving the front curtain and the rear curtain of the focal-plane shutter 48 along the Y direction (for example, from the brighter side to the darker side of the plurality of pixel columns 33) in a state where the front curtain and the rear curtain of the focal-plane shutter 48 are fully closed.

In the exposure time determination processing illustrated in FIG. 10, the processing in steps ST300 to ST308 is the same as the processing in steps ST200 to ST208 illustrated in FIG. 9. In the exposure time determination processing illustrated in FIG. 10, the processing in steps ST310 to ST314 is the same as the processing in steps ST214 to ST218 illustrated in FIG. 9. The reference exposure time used in the processing in step ST302 is an example of a “first exposure time” according to the disclosed technology. The reference pixel column used in the processing in step ST308 is an example of a “second reference region in the photoelectric conversion region” according to the disclosed technology. The ratio calculated in step ST312 is an example of a “second degree of difference” according to the disclosed technology. The exposure time of the reference pixel column among a plurality of exposure times determined in step ST314 is an example of the “first exposure time” according to the disclosed technology.

In the exposure time determination processing illustrated in FIG. 10, in step ST316, the processor 58 exposes each pixel column 33 for the exposure time determined for each pixel column 33 in step ST314. After the processing in step ST316 is executed, the exposure time determination processing transitions to step ST318.

In step ST318, the processor 58 acquires the representative signal level of each of all pixel columns 33. After the processing in step ST318 is executed, the exposure time determination processing transitions to step ST320.

While an example of acquiring the representative signal level of each of all pixel columns 33 is described, this is merely an example. For example, only the representative signal level of the pixel column 33 at an end in the −Y direction among all pixel columns 33 in the photoelectric conversion region 32, the representative signal level of the reference pixel column, and the representative signal level of the pixel column 33 at an end in the +Y direction among all pixel columns 33 in the photoelectric conversion region 32 may be acquired.

In step ST320, the processor 58 determines whether or not each of all representative signal levels acquired in step 318 falls within the reference range. The reference range used in the processing in step ST320 is an example of a “reference range” according to the disclosed technology. A first example of the reference range is a range of a signal level without darkening and washout in the captured image 29. A second example of the reference range is a range of a signal level without washout in the captured image 29.

In step ST320, in a case where each of all representative signal levels acquired in step 318 does not fall within the reference range, a negative determination is made, and the exposure time determination processing transitions to step ST308. In step ST320, in a case where each of all representative signal levels acquired in step 318 falls within the reference range, a positive determination is made, and the exposure time determination processing transitions to step ST320. By executing the processing in steps ST308 to ST320, the exposure time of each of all pixel columns 33 is adjusted to a time in which each of all representative signal levels falls within the reference range.

In step ST322, the processor 58 confirms the exposure time determined for each pixel column 33 in step ST314. While the exposure time of each pixel column 33 is determined in advance in the first embodiment, the exposure time confirmed in step ST322 may be applied as the exposure time of each pixel column 33.

As described above, in the third embodiment, the exposure time of each pixel column 33 from the pixel column 33 on the darker side to the pixel column 33 on the brighter side of the plurality of pixel columns 33 in the photoelectric conversion region 32 is determined in the same manner as in the second embodiment. The exposure time for each pixel column 33 is adjusted to the time in which each representative signal level obtained by exposing each pixel column 33 in the exposure time for each pixel column 33 falls within the reference range. Accordingly, a suitable exposure time (for example, an exposure time not causing brightness unevenness in the captured image 29, an exposure time not causing overexposure, or an exposure time not causing underexposure) for each pixel column 33 from the pixel column 33 on the darker side to the pixel column 33 on the brighter side of the plurality of pixel columns 33 in the photoelectric conversion region 32 can be determined.

### Fourth Embodiment

While each embodiment describes a case where the imaging range 36 illustrated in FIG. 2 is imaged by the imaging apparatus 14, a fourth embodiment describes exposure time determination processing performed in a case where an imaging range different from the imaging range 36 is also imaged by the imaging apparatus 14. In the fourth embodiment, constituents described in each embodiment will be designated by the same reference numerals and will not be described, and different parts from each embodiment will be described.

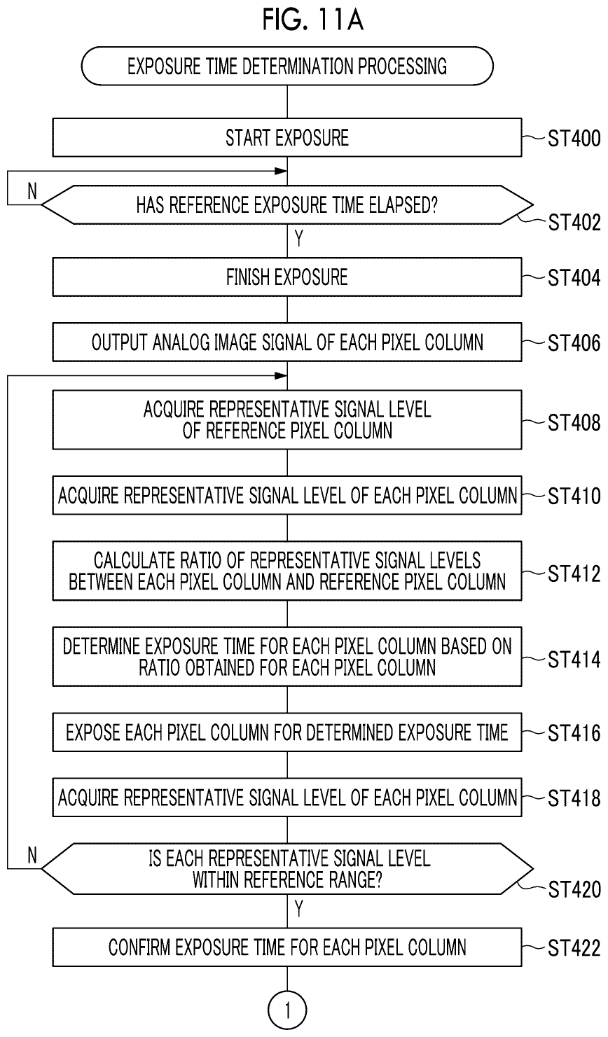

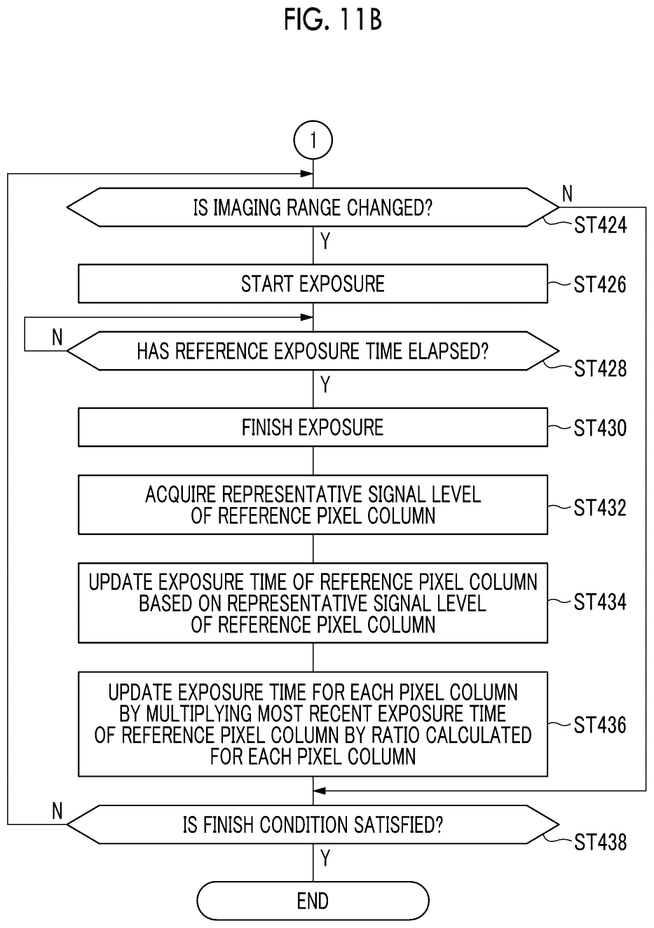

FIGS. 11A and 11B illustrate an example of a flow of the exposure time determination processing performed by the processor 58 according to the fourth embodiment.

Description of the fourth embodiment assumes that the supplementary light 28 is emitted to the side closer to the subject 27 from the illumination device 22. Description of the fourth embodiment assumes that the exposure of the photoelectric conversion region 32 is performed by moving the front curtain and the rear curtain of the focal-plane shutter 48 along the Y direction (for example, from the brighter side to the darker side of the plurality of pixel columns 33) in a state where the front curtain and the rear curtain of the focal-plane shutter 48 are fully closed.

Description of the fourth embodiment assumes that the exposure time determination processing is performed by the processor 58 in a case where an imaging target is changed from the imaging range 36 to another imaging range in imaging using the image sensor 26.

In the exposure time determination processing illustrated in FIG. 11A, the processing in steps ST400 to ST422 is the same as the processing in steps ST300 to ST322 illustrated in FIG. 10. The reference exposure time used in step ST402 and the exposure time of the reference pixel column among a plurality of exposure times determined in step ST414 is an example of a “second exposure time” according to the disclosed technology. The reference pixel column used in the processing in step ST408 is an example of a “third reference region in the photoelectric conversion region” according to the disclosed technology. The ratio calculated in step ST412 is an example of a “third degree of difference” according to the disclosed technology.

In step ST424 illustrated in FIG. 11B, the processor 58 determines whether or not the imaging target of the imaging apparatus 14 is changed from the imaging range 36 to an imaging range other than the imaging range 36. In step ST424, in a case where the imaging target of the imaging apparatus 14 is not changed from the imaging range 36 to the imaging range other than the imaging range 36, a negative determination is made, and the exposure time determination processing transitions to step ST438. In step ST424, in a case where the imaging target of the imaging apparatus 14 is changed from the imaging range 36 to the imaging range other than the imaging range 36, a positive determination is made, and the exposure time determination processing transitions to step ST426.

The processing in steps ST426 to ST430 is the same as the processing in steps ST400 to ST404 illustrated in FIG. 11A.

In step ST432, the processor 58 acquires the representative signal level of the reference pixel column among all pixel columns 33. After the processing in step ST432 is executed, the exposure time determination processing transitions to step ST434. The reference pixel column used in step ST432 is an example of the “third reference region in the photoelectric conversion region” according to the disclosed technology.

In step ST434, the processor 58 updates the exposure time of the reference pixel column based on the representative signal level of the reference pixel column. The current exposure time of the reference pixel column (for example, the exposure time of the reference pixel column among the exposure times of all pixel columns 33 determined in step ST414) is updated by multiplying the current exposure time of the reference pixel column by a first coefficient. For example, the first coefficient used here is a ratio of the representative signal level obtained in step ST432 to the representative signal level obtained in step ST408. After the processing in step ST434 is executed, the exposure time determination processing transitions to step ST436. The exposure time updated by executing the processing in step ST434 is an example of a “second reference exposure time determined for the third reference region” according to the disclosed technology.

In step ST436, the processor 58 updates the exposure time for each pixel column 33 by multiplying the most recent exposure time of the reference pixel column by a ratio calculated for each pixel column 33. The most recent exposure time of the reference pixel column refers to the exposure time updated and obtained in step ST434. The ratio calculated for each pixel column 33 refers to the ratio calculated for each pixel column 33 in step ST412. Updating of the exposure time for each pixel column 33 refers to updating of the exposure time determined for each pixel column 33 in step ST416 or re-updating of the exposure time updated for each pixel column 33 in previous step ST434. After the processing in step ST436 is executed, the exposure time determination processing transitions to step ST438.

In step ST438, the processor 58 determines whether or not a condition for finishing the exposure time determination processing is satisfied. A first example of the condition for finishing the exposure time determination processing is a condition that the imaging system 10 has performed imaging at all predetermined positions (for example, all waypoints). A second example of the condition for finishing the exposure time determination processing is a condition that an instruction to finish the exposure time determination processing is provided to the imaging apparatus 14 from the outside (for example, the communication device).

In step ST438, in a case where the condition for finishing the exposure time determination processing is not satisfied, a negative determination is made, and the exposure time determination processing transitions to step ST424. In step ST438, in a case where the condition for finishing the exposure time determination processing is satisfied, a positive determination is made, and the exposure time determination processing is finished.

As described above, in the fourth embodiment, the exposure time for each pixel column 33 from the pixel column 33 on the darker side to the pixel column 33 on the brighter side of the plurality of pixel columns 33 in the photoelectric conversion region 32 before the imaging target is changed from the imaging range 36 to the other imaging range is determined in the same manner as in the second and third embodiments. The exposure time for each pixel column 33 is adjusted to the time in which each representative signal level obtained by exposing each pixel column 33 in the exposure time for each pixel column 33 falls within the reference range, in the same manner as in the third embodiment. After the imaging target is changed from the imaging range 36 to the other imaging range, the current exposure time set for the reference pixel column is updated based on the representative signal level of the reference pixel column. The exposure time for each pixel column 33 is updated by multiplying the most recent exposure time of the reference pixel column by the ratio calculated for each pixel column 33. Accordingly, the ratio for each pixel column 33 does not need to be calculated each time the imaging target is changed from the imaging range 36 to the other imaging range. Accordingly, a suitable exposure time (for example, an exposure time not causing brightness unevenness in the captured image 29, an exposure time not causing overexposure, or an exposure time not causing underexposure) for each pixel column 33 from the pixel column 33 on the darker side to the pixel column 33 on the brighter side of the plurality of pixel columns 33 in the photoelectric conversion region 32 can be easily determined, compared to that in a case where the ratio for each pixel column 33 is calculated each time the imaging range changes.

### Fifth Embodiment

While each embodiment describes a case where the supplementary light 28 is emitted to the side closer to the subject 27, a fifth embodiment describes a case where a flash is emitted to the side closer to the subject 27. The flash is light used in accordance with a timing at which imaging using the image sensor 26 is performed, and is instantaneously emitted from the illumination device 22. In the fifth embodiment, constituents described in each embodiment will be designated by the same reference numerals and will not be described, and different parts from each embodiment will be described.

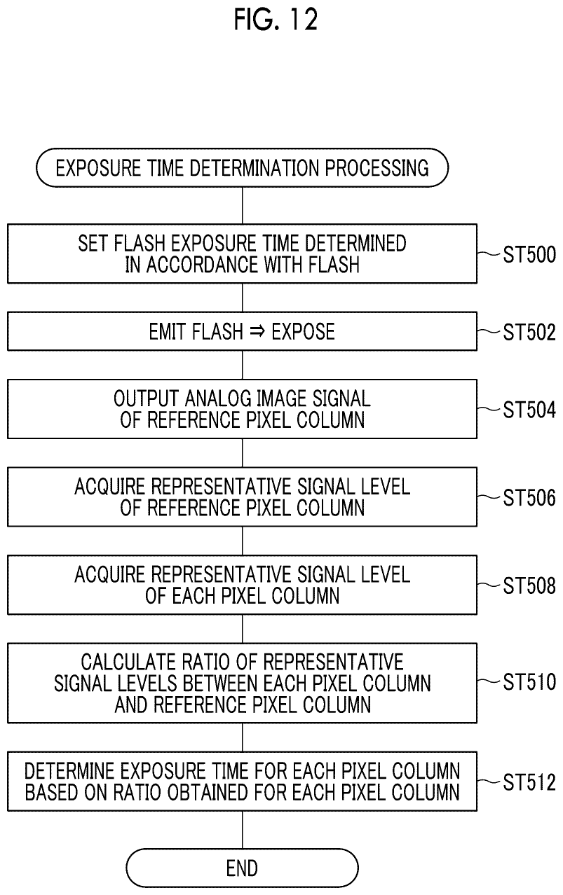

FIG. 12 illustrates an example of a flow of the exposure time determination processing performed by the processor 58 according to the fifth embodiment.

Description of the fifth embodiment assumes that the exposure of the photoelectric conversion region 32 is performed by moving the front curtain and the rear curtain of the focal-plane shutter 48 from the darker side to the brighter side of the plurality of pixel columns 33 in a state where the front curtain and the rear curtain of the focal-plane shutter 48 are fully closed.

In the exposure time determination processing illustrated in FIG. 12, in step ST500, the processor 58 sets a flash exposure time determined in accordance with the flash. The flash exposure time is an example of a “third exposure time” according to the disclosed technology. Examples of the flash exposure time include an exposure time determined in advance for a guide number. After the processing in step ST500 is executed, the exposure time determination processing transitions to step ST502.

In step ST502, the processor 58 causes the illumination device 22 to emit the flash. The processor 58 exposes the photoelectric conversion region 32 for the flash exposure time by operating the focal-plane shutter 48. After the processing in step ST502 is executed, the exposure time determination processing transitions to step ST504.

The processing in steps ST504 to ST512 is the same as the processing in steps ST408 to ST414 illustrated in FIG. 11A. The representative signal level acquired in step ST506 is an example of a “signal level of a fourth reference region” according to the disclosed technology. The representative signal level acquired for each pixel column 33 in step ST508 is an example of a “plurality of signal levels obtained from a plurality of divided regions” according to the disclosed technology. The ratio calculated in step ST510 is an example of a “fourth degree of difference” according to the disclosed technology.

In the first embodiment, the exposure time of each pixel column 33 is determined in advance. However, in a case where the flash is used in accordance with the timing at which the imaging using the image sensor 26 is performed, the exposure time determined in step ST512 may be applied as the exposure time of each pixel column 33.

As described above, in the fifth embodiment, in a case where the flash is used in accordance with the timing at which the imaging using the image sensor 26 is performed, the exposure time for each pixel column 33 is determined as described in the second to fourth embodiments, using the ratio obtained for each pixel column 33 by exposing each pixel column 33 for the flash exposure time. Accordingly, even in a case where the flash is used in accordance with the timing at which the imaging using the image sensor 26 is performed, a suitable exposure time for each pixel column 33 from the pixel column 33 on the darker side to the pixel column 33 on the brighter side of the plurality of pixel columns 33 in the photoelectric conversion region 32 can be determined.

In the fifth embodiment, the exposure time of the reference pixel column is determined based on the representative signal level obtained in a case where the flash is emitted. However, the disclosed technology is not limited to this. For example, the exposure time obtained for the reference pixel column before performing imaging using the flash may be updated in the same manner as in step ST434 illustrated in FIG. 11B. In this case, for example, first, the current exposure time of the reference pixel column (for example, the exposure time of the reference pixel column among the exposure times of all pixel columns 33 determined in step ST414) is updated by multiplying the current exposure time of the reference pixel column by a second coefficient. For example, the second coefficient used here is a ratio of the representative signal level obtained in step ST506 to the representative signal level obtained in step ST508.

In the fifth embodiment, the exposure time for each pixel column 33 is determined based on the representative signal level obtained in a case where the flash is emitted. However, the disclosed technology is not limited to this. For example, in a case where the flash is used in accordance with the timing at which the imaging using the image sensor 26 is performed, the exposure time obtained for each pixel column 33 (for example, the exposure time determined in step ST414 illustrated in FIG. 11A) may be updated before performing imaging using the flash, in the same manner as in step ST434 illustrated in FIG. 11B. The exposure time updated for each pixel column 33 is used as the exposure time of each pixel column 33 in a case where imaging using the flash is performed.

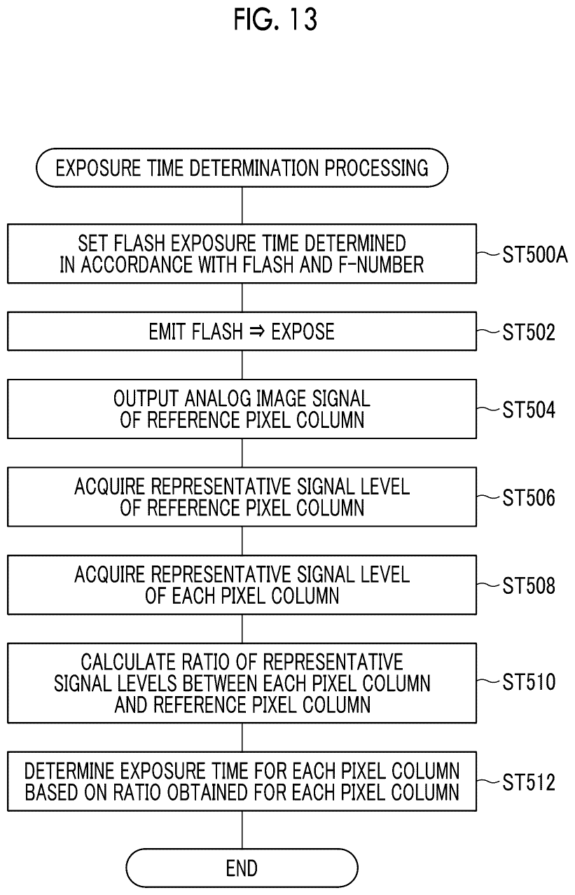

The fifth embodiment describes a case where the flash is used for imaging using the image sensor 26. However, the disclosed technology is also applicable to a case where the stop 52C is adjusted in imaging using the image sensor 26. For example, as in flashmatic, in a case where an F-number is adjusted at a timing at which imaging with the flash is performed, the exposure time determination processing in which step ST500A is applied instead of step ST500 is performed by the processor 58, as illustrated in, for example, FIG. 13.

In step ST500A of the exposure time determination processing illustrated in FIG. 13, the processor 58 sets the flash exposure time determined in accordance with the guide number of the flash and with the F-number of the stop 52C. Even in this case, the same effect as the fifth embodiment can be achieved.

### Sixth Embodiment

A sixth embodiment describes shutter speed determination processing. The shutter speed determination processing is processing of determining a moving speed of the focal-plane shutter 48 (hereinafter, referred to as the “shutter speed”) in a case where the exposure time for each pixel column 33 is determined in accordance with the moving speed of the focal-plane shutter 48. In the sixth embodiment, constituents described in each embodiment will be designated by the same reference numerals and will not be described, and different parts from each embodiment will be described.

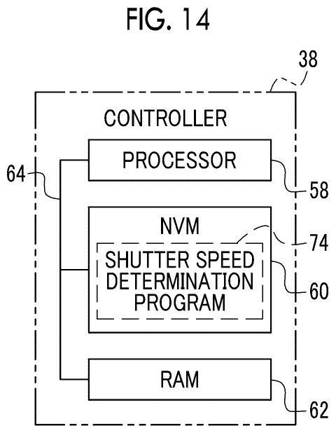

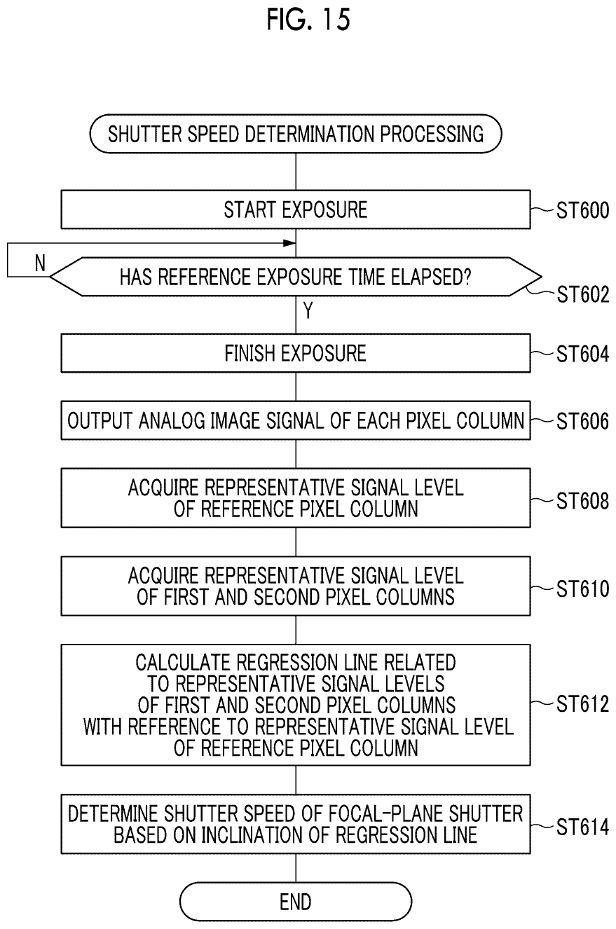

For example, as illustrated in FIG. 14, a shutter speed determination program 74 is stored in the NVM 60. The processor 58 reads out the shutter speed determination program 74 from the NVM 60 and executes the read shutter speed determination program 74 on the RAM 62. The processor 58 performs the shutter speed determination processing (refer to FIG. 15) in accordance with the shutter speed determination program 74 executed on the RAM 62.

FIG. 15 illustrates an example of a flow of the shutter speed determination processing performed by the processor 58 according to the sixth embodiment.

Description of the sixth embodiment assumes that the supplementary light 28 is emitted to the side closer to the subject 27 from the illumination device 22. Description of the sixth embodiment assumes that the exposure of the photoelectric conversion region 32 is performed by moving the front curtain and the rear curtain of the focal-plane shutter 48 along the Y direction (for example, from the brighter side to the darker side of the plurality of pixel columns 33) in a state where the front curtain and the rear curtain of the focal-plane shutter 48 are fully closed.

In the shutter speed determination processing illustrated in FIG. 15, the processing in steps ST600 to ST608 is the same as the processing in steps ST400 to ST408 illustrated in FIG. 11A. The reference exposure time used in step ST602 is an example of a “fourth exposure time” according to the disclosed technology. The reference pixel column used in step ST608 is an example of a “fifth reference region in the photoelectric conversion region” according to the disclosed technology. The representative signal level acquired in step ST608 is an example of a “signal level of the fifth reference region” according to the disclosed technology.

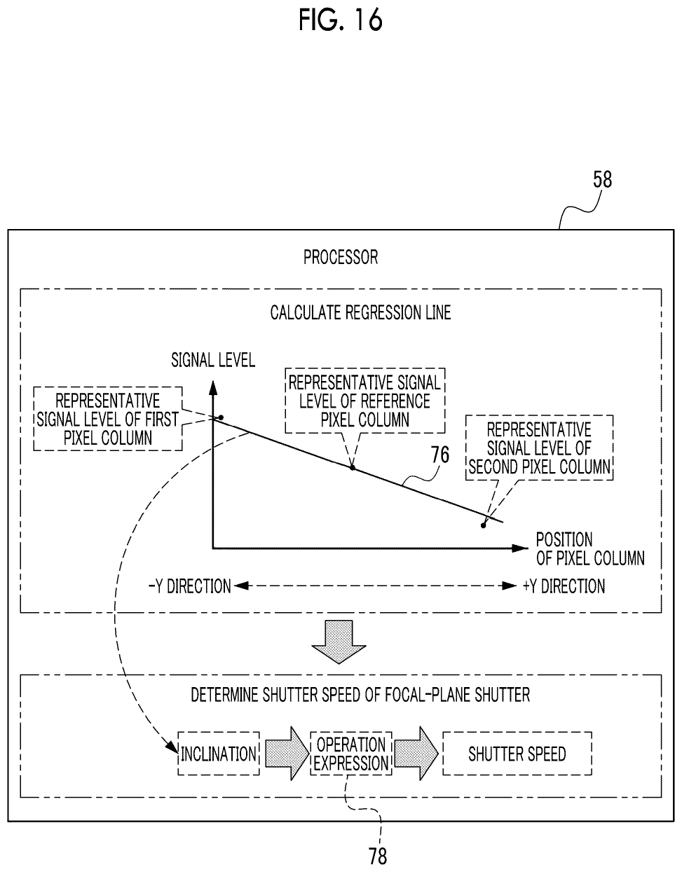

In step ST610, the processor 58 acquires a representative signal level of a first pixel column and a representative signal level of a second pixel column. For example, the first pixel column refers to the pixel column 33 positioned at an end in the −Y direction among all pixel columns 33 (refer to FIG. 16). For example, the second pixel column refers to the pixel column 33 positioned at an end in the +Y direction among all pixel columns 33 (refer to FIG. 16). The representative signal level of the first pixel column and the representative signal level of the second pixel column are examples of the “plurality of signal levels obtained from the plurality of divided regions” according to the disclosed technology. After the processing in step ST610 is executed, the shutter speed determination processing transitions to step ST612.

In step ST612, the processor 58 calculates a regression line 76 related to the representative signal levels of the first and second pixel columns with reference to the representative signal level of the reference pixel column (that is, the representative signal level acquired in step ST608) (refer to FIG. 16). After the processing in step ST612 is executed, the shutter speed determination processing transitions to step ST614.

In step ST614, the processor 58 determines the shutter speed of the focal-plane shutter 48 based on an inclination of the regression line 76 calculated in step ST612. In this case, for example, as illustrated in FIG. 16, the shutter speed of the focal-plane shutter 48 is determined by deriving the shutter speed of the focal-plane shutter 48 from an operation expression 78. The operation expression 78 is an operation expression that takes the inclination of the regression line 76 as an independent variable and that takes the shutter speed of the focal-plane shutter 48 as a dependent variable. The shutter speed determined in step ST614 is an example of a “moving speed of a focal-plane shutter” according to the disclosed technology. After the processing in step ST614 is executed, the shutter speed determination processing is finished.

The shutter speed of the focal-plane shutter 48 may be derived from a table in which the inclination of the regression line 76 and the shutter speed of the focal-plane shutter 48 are associated with each other, instead of the operation expression 78.

As described above, in the sixth embodiment, the shutter speed of the focal-plane shutter 48 is determined based on a result (for example, the inclination of the regression line 76) of regression analysis performed based on the representative signal level of the reference pixel column, the representative signal level of the first pixel column, and the representative signal level of the second pixel column. Accordingly, a shutter speed required for implementing a suitable exposure time for each pixel column 33 from the pixel column 33 on the darker side to the pixel column 33 on the brighter side of the plurality of pixel columns 33 can be determined as the shutter speed of the focal-plane shutter 48.

While the fifth embodiment describes an example of performing the regression analysis based on the representative signal level of the reference pixel column, the representative signal level of the first pixel column, and the representative signal level of the second pixel column, this is merely an example, and the regression analysis may be performed based on the representative signal levels of four or more pixel columns 33.

### Other Modification Examples

Hereinafter, for convenience of description, the exposure time control program 70, the exposure time determination program 72, and the shutter speed determination program 74 will be referred to as an “imaging support program” unless distinction therebetween is required. Hereinafter, for convenience of description, the exposure time control processing, the exposure time determination processing, and the shutter speed determination processing will be referred to as “imaging support processing” unless distinction therebetween is required.

While each embodiment describes an example of acquiring the representative signal level in units of the pixel columns 33, the disclosed technology is not limited to this. For example, the photoelectric conversion region 32 may be divided in units of a plurality of pixel columns 33. In this case, the representative signal level may be acquired for each plurality of pixel columns 33.

Each embodiment describes an example in which a difference in brightness occurs along the Y direction in the photoelectric conversion region 32. However, for example, in a case where a difference in brightness occurs along the Z direction in the photoelectric conversion region 32, a posture of the imaging apparatus body 20 may be changed such that the direction of the image sensor 26 is rotated by 90 degrees about the X axis. That is, the posture of the imaging apparatus body 20 may be changed such that a longitudinal direction of the pixel column 33 (that is, an arrangement direction of the plurality of pixels 34) is orthogonal to a direction in which the difference in brightness occurs in the photoelectric conversion region 32.

While an example of changing the posture of the imaging apparatus body 20 is described, this is merely an example. For example, a rotation mechanism that changes a posture of the image sensor 26 by rotating the image sensor 26 about the optical axis OA may be incorporated in the imaging apparatus body 20. In this case, the posture of the image sensor 26 may be changed to a posture in which the longitudinal direction of the pixel column 33 is orthogonal to the direction in which the difference in brightness occurs in the photoelectric conversion region 32, by operating the rotation mechanism without changing the posture of the imaging apparatus body 20.

While each embodiment describes an example of integrating the illumination device 22 with the imaging apparatus body 20, this is merely an example, and the illumination device 22 may be attached to the moving object 12 separately from the imaging apparatus body 20. Even in this case, as in each embodiment, the supplementary light 28 is emitted to the side closer to the subject 27 from a position around the imaging apparatus body 20, and a difference in brightness occurs along one direction in the photoelectric conversion region 32. Thus, the same effect as each embodiment can be achieved by performing the exposure time control processing, the exposure time determination processing, and the shutter speed determination processing.

While each embodiment describes an example of performing the imaging support processing via the processor 58 of the controller 38 included in the imaging apparatus body 20, the disclosed technology is not limited to this, and the device that performs the imaging support processing may be provided outside the imaging apparatus body 20. Examples of the device provided outside the imaging apparatus body 20 include at least one server and/or at least one personal computer that is connected to and capable of communicating with the imaging apparatus body 20. The imaging support processing may be performed in a distributed manner by a plurality of devices.

While each embodiment describes an example of storing the imaging support processing program in the NVM 60, the disclosed technology is not limited to this. For example, the imaging support processing program may be stored in a portable non-transitory storage medium such as an SSD or a USB memory. The imaging support processing program stored in the non-transitory storage medium is installed on the controller 38 of the imaging apparatus body 20. The processor 58 executes the imaging support processing in accordance with the imaging support program.

The imaging support processing program may be stored in a storage device of another computer, a server apparatus, or the like connected to the imaging apparatus body 20 through a network, and the imaging support processing program may be downloaded in response to a request of the imaging apparatus body 20 and installed on the controller 38.

The storage device of the other computer, the server apparatus, or the like connected to the imaging apparatus body 20, or the NVM 60 is not required to store the entire imaging support program and may store a part of the imaging support processing program.

The following various processors can be used as a hardware resource for executing the imaging support processing. Examples of the processor include a CPU that is a general-purpose processor functioning as the hardware resource for executing the imaging support processing by executing software, that is, a program. Examples of the processor include a dedicated electric circuit that is a processor such as an FPGA, a PLD, or an ASIC having a circuit configuration dedicatedly designed to execute specific processing. Any of the processors has a memory incorporated therein or connected thereto, and any of the processors executes the imaging support processing using the memory.

The hardware resource for executing the imaging support processing may be composed of one of the various processors or may be composed of a combination of two or more processors of the same type or different types (for example, a combination of a plurality of FPGAs or a combination of a CPU and an FPGA). The hardware resource for executing the imaging support processing may be one processor.

As a first example of the hardware resource composed of one processor, one processor is composed of a combination of one or more CPUs and software, and this processor functions as the hardware resource for executing the imaging support processing. As a second example, as represented by an SoC or the like, a processor that implements functions of the entire system including a plurality of hardware resources for executing the imaging support processing in one IC chip is used. Accordingly, the imaging support processing is implemented using one or more of the various processors as the hardware resource.

More specifically, an electric circuit in which circuit elements such as semiconductor elements are combined can be used as a hardware structure of the various processors. The imaging support processing is merely an example. Accordingly, it is possible to delete an unnecessary step, add a new step, or change a processing order without departing from the gist of the present disclosure.

Above described content and illustrated content are detailed description for parts according to the disclosed technology and are merely an example of the disclosed technology. For example, description related to the above configurations, functions, actions, and effects is description related to examples of configurations, functions, actions, and effects of the parts according to the disclosed technology. Thus, it is possible to remove unnecessary parts, add new elements, or replace parts in the above described content and the illustrated content without departing from the gist of the disclosed technology. Particularly, description related to common technical knowledge or the like not required to be described for embodying the disclosed technology is omitted in the above described content and the illustrated content in order to avoid complication and facilitate understanding of the parts according to the disclosed technology.

In the present specification, “A and/or B” is synonymous with “at least one of A or B”. That is, “A and/or B” may mean only A, only B, or a combination of A and B. In the present specification, the same approach as “A and/or B” applies to an expression of three or more matters connected with “and/or”.

All documents, patent applications, and technical standards described in the present specification are incorporated in the present specification by reference to the same extent as those in a case where each of the documents, patent applications, and technical standards are specifically and individually indicated to be incorporated by reference.

What is claimed is:

1. An imaging support device comprising:
a processor configured to control an exposure time of a photoelectric conversion region of an image sensor having the photoelectric conversion region in which a plurality of pixels are two-dimensionally disposed,
wherein the processor is configured to, in a case where an incidence ray on the photoelectric conversion region causes a difference in brightness along one direction in the photoelectric conversion region, perform a control of reducing the exposure time from a divided region on a darker side to a divided region on a brighter side of a plurality of divided regions into which the photoelectric conversion region is divided along the one direction.

2. The imaging support device according to claim 1,
wherein the divided region is a region in which the pixels are linearly arranged in a direction intersecting with the one direction.

3. The imaging support device according to claim 1,
wherein the incidence ray is light including reflected light obtained by reflection, on a subject, of supplementary light emitted from an illumination device used for imaging using the image sensor.

4. The imaging support device according to claim 1,
wherein the processor is configured to, in a case where a mechanical shutter and/or an electronic shutter is used for imaging using the image sensor, control the exposure time of the photoelectric conversion region by controlling the mechanical shutter and/or the electronic shutter.

5. The imaging support device according to claim 1,
wherein the processor is configured to reduce the exposure time from the divided region on the darker side to the divided region on the brighter side of the plurality of divided regions by controlling an exposure start timing and/or an exposure end timing for the plurality of divided regions.

6. The imaging support device according to claim 5,
wherein the processor is configured to perform a control of delaying the exposure start timing for the plurality of divided regions from the divided region on the darker side to the divided region on the brighter side of the plurality of divided regions and matching the exposure end timing for the plurality of divided regions.

7. The imaging support device according to claim 6,
wherein the processor is configured to perform a control of matching the exposure end timing for the plurality of divided regions using a global shutter system.

8. The imaging support device according to claim 5,
wherein the processor is configured to perform a control of matching the exposure start timing for the plurality of divided regions and delaying the exposure end timing for the plurality of divided regions from the divided region on the brighter side to the divided region on the darker side of the plurality of divided regions.

9. The imaging support device according to claim 8,
wherein the processor is configured to perform a control of matching the exposure start timing for the plurality of divided regions using a global shutter system.

10. The imaging support device according to claim 5,
wherein the processor is configured to perform a control of delaying the exposure start timing for the plurality of divided regions from the divided region on the darker side to the divided region on the brighter side of the plurality of divided regions, delaying the exposure end timing for the plurality of divided regions from the divided region on the darker side to the divided region on the brighter side of the plurality of divided regions, and reducing the exposure time from the divided region on the darker side to the divided region on the brighter side of the plurality of divided regions.

11. The imaging support device according to claim 1,
wherein the exposure time for each divided region from the divided region on the darker side to the divided region on the brighter side of the plurality of divided regions is determined in accordance with a first degree of difference, and
the first degree of difference is a degree of difference between a signal level of a first reference region in the photoelectric conversion region in a case where the exposure time of the photoelectric conversion region is shorter than a first reference exposure time, and a plurality of signal levels obtained from the plurality of divided regions.

12. The imaging support device according to claim 11,
wherein the first reference exposure time is shorter than a time in which the signal level of the first reference region is saturated.

13. The imaging support device according to claim 1,
wherein the exposure time for each divided region from the divided region on the darker side to the divided region on the brighter side of the plurality of divided regions is determined in accordance with a second degree of difference,
the second degree of difference is a degree of difference between a signal level of a second reference region in the photoelectric conversion region in a case where the exposure time of the photoelectric conversion region is a first exposure time, and a plurality of signal levels obtained from the plurality of divided regions, and
the exposure time for each divided region from the divided region on the darker side to the divided region on the brighter side of the plurality of divided regions is adjusted to a time in which the plurality of signal levels fall within a reference range.

14. The imaging support device according to claim 1,
wherein, in a case where an imaging range is changed in imaging using the image sensor,
the exposure time for each divided region from the divided region on the darker side to the divided region on the brighter side of the plurality of divided regions before the imaging range is changed is determined in accordance with a third degree of difference,
the third degree of difference is a degree of difference between a signal level of a third reference region in the photoelectric conversion region in a case where the exposure time of the photoelectric conversion region is a second exposure time, and a plurality of signal levels obtained from the plurality of divided regions, and
the exposure time for each divided region from the divided region on the darker side to the divided region on the brighter side of the plurality of divided regions after the imaging range is changed is determined in accordance with a second reference exposure time determined for the third reference region and with the third degree of difference.

15. The imaging support device according to claim 1,
wherein, in a case where a flash is used in accordance with a timing at which imaging using the image sensor is performed,
the exposure time for each divided region from the divided region on the darker side to the divided region on the brighter side of the plurality of divided regions is determined in accordance with a fourth degree of difference, and
the fourth degree of difference is a degree of difference between a signal level of a fourth reference region in the photoelectric conversion region in a case where the exposure time of the photoelectric conversion region is a third exposure time determined in accordance with the flash, and a plurality of signal levels obtained from the plurality of divided regions.

16. The imaging support device according to claim 15,
wherein, in a case where a stop is adjusted in imaging using the image sensor,
the third exposure time is determined in accordance with the flash and with a value of the stop.

17. The imaging support device according to claim 1,
wherein, in a case where the exposure time of the photoelectric conversion region is determined in accordance with a moving speed of a focal-plane shutter,
the moving speed is determined based on a result of regression analysis performed based on a signal level of a fifth reference region in the photoelectric conversion region in a case where the photoelectric conversion region is exposed for a fourth exposure time and on a plurality of signal levels obtained from the plurality of divided regions.

18. An imaging apparatus comprising:
the imaging support device according to claim 1; and
the image sensor.

19. An imaging support method comprising:
exposing a photoelectric conversion region of an image sensor having the photoelectric conversion region in which a plurality of pixels are two-dimensionally disposed; and
performing, in a case where an incidence ray on the photoelectric conversion region causes a difference in brightness along one direction in the photoelectric conversion region, a control of reducing an exposure time from a divided region on a darker side to a divided region on a brighter side of a plurality of divided regions into which the photoelectric conversion region is divided along the one direction.

20. A non-transitory computer-readable storage medium storing a program executable by a computer that controls an exposure time of a photoelectric conversion region of an image sensor having the photoelectric conversion region in which a plurality of pixels are two-dimensionally disposed, to execute a process comprising:
performing, in a case where an incidence ray on the photoelectric conversion region causes a difference in brightness along one direction in the photoelectric conversion region, a control of reducing the exposure time from a divided region on a darker side to a divided region on a brighter side of a plurality of divided regions into which the photoelectric conversion region is divided along the one direction.
